(19) United States
(12) Patent Application Publication
(10) Pub. No.: US 2025/0147738 A1
(43) Pub. Date: May 8, 2025

(54) SCENARIO MANAGEMENT APPARATUS AND RECORDING MEDIUM

(71) Applicant: Keyence Corporation, Osaka (JP)

(72) Inventor: Kazuki NATORI, Osaka (JP)

(73) Assignee: Keyence Corporation, Osaka (JP)

(21) Appl. No.: 18/894,046

(22) Filed: Sep. 24, 2024

(30) Foreign Application Priority Data
Nov. 2, 2023 (JP) 2023-188167

(51) Int. Cl. G06F 8/34

(52) U.S. Cl. CPC G06F 8/34

(57) ABSTRACT

An appropriate prompt for a purpose of scenario generation can be input to a machine learning model in a mode easy for a user. A user instruction in a natural language format by the user is input to an LLM 12 (machine learning model) that has learned natural language processing. Accordingly, the LLM 12 can grasp the meaning of the user instruction. Further, rule information for describing a scenario in a general-purpose programming language is input to the LLM 12. Accordingly, the source code corresponding to the meaning of the user instruction can be appropriately generated based on the rule information. That is, it is possible to input the appropriate prompt for the purpose of the scenario generation to the LLM 12 in the mode easy for the user.

### CROSS-REFERENCE TO RELATED APPLICATIONS

The present application claims foreign priority based on Japanese Patent Application No. 2023-188167, filed Nov. 2, 2023, the contents of which are incorporated herein by reference.

### BACKGROUND OF THE INVENTION

### 1. Technical Field

The present invention relates to a Robotic Process Automation (RPA) technology for reducing a work load of a user by automating a work executed by the user using a computer.

### 2. Description of the Related Art

The RPA can be used to automate a work executed by a user by operating an application or the like operated by a computer. The RPA automates the work by executing a scenario (also referred to as a “flow”) indicating an execution procedure of processing by the computer.

As described in JP2023-54409A, this scenario is generated by combining a plurality of activities each indicating processing to be executed by the computer.

### SUMMARY OF THE INVENTION

However, it is not easy for a user who is not familiar with contents of the activities that can be used in the RPA to select and array appropriate activities in order to execute a target scenario. Accordingly, there has been a demand for development of a tool that enables the user to generate the scenario by inputting a target function in a natural language. Therefore, it is conceivable to use a machine learning model that has learned the natural language such as a large language model (LLM). However, it is difficult for a current machine learning model to accurately output a source code of the scenario for realizing the function with respect to an input of the function in the natural language. In other words, there is a problem that it is difficult to convert the function indicated by the natural language input by the user into an appropriate prompt for a purpose of the generation of the source code of the scenario.

The present invention has been made in view of the above problems, and an object thereof is to enable a user to input an appropriate prompt for a purpose of scenario generation to a machine learning model in a mode easy for the user.

A scenario management apparatus according to one embodiment of the present invention is a scenario management apparatus that manages a scenario for automating an operation on another application program. The scenario management apparatus includes an acceptance unit that accepts a user instruction in a natural language format by a user, a rule information acquisition unit that acquires rule information for describing the scenario in a general-purpose programming language from a storage unit, an input unit that inputs the user instruction accepted by the acceptance unit and the rule information acquired by the rule information acquisition unit to a machine learning model that has learned natural language processing, an output information acquisition unit that acquires output information including a source code that describes the scenario, the source code being generated by the machine learning model in the general-purpose programming language according to the user instruction and the rule information, and a display generation unit that converts the source code included in the output information into display information to be displayed on a GUI.

A scenario management apparatus according to another embodiment of the present invention is a scenario management apparatus that manages a scenario for automating an operation on another application program. The scenario management apparatus includes an acceptance unit that accepts a user instruction in a natural language format by a user, a rule information acquisition unit that acquires rule information for describing the scenario in a general-purpose programming language from a storage unit, an input unit that inputs the user instruction accepted by the acceptance unit and the rule information acquired by the rule information acquisition unit to a machine learning model that has learned natural language processing, an output information acquisition unit that acquires output information including a source code that describes the scenario, the source code being generated by the machine learning model in the general-purpose programming language according to the user instruction and the rule information, and an editing operation unit that retains the source code included in the output information in a mode editable by the user in the storage unit.

A scenario management program according to still another embodiment of the present invention is a computer-readable recording medium storing a scenario management program causing a computer to function as a scenario management apparatus that manages a scenario for automating an operation on another application program, the scenario management program causing the computer to execute a step of accepting a user instruction in a natural language format by a user, acquiring rule information for describing the scenario in a general-purpose programming language from a storage unit, inputting the user instruction and the rule information to a machine learning model that has learned natural language processing, acquiring output information including a source code describes the scenario, the source code being generated by the machine learning model in the general-purpose programming language according to the user instruction and the rule information, and converting the source code included in the output information into display information to be displayed on a GUI.

A scenario management program according to still another embodiment of the present invention is a computer-readable recording medium storing a scenario management program causing a computer to function as a scenario management apparatus that manages a scenario for automating an operation on another application program, the scenario management program causing the computer to execute a step of accepting a user instruction in a natural language format by a user, acquiring rule information for describing the scenario in a general-purpose programming language from a storage unit, inputting the user instruction and the rule information to a machine learning model that has learned natural language processing, acquiring output information including a source code describes the scenario, the source code being generated by the machine learning model in the general-purpose programming language according to the user instruction and the rule information, and retaining the source code included in the output information in a mode editable by the user in the storage unit.

The recording medium according to the present invention stores the scenario management program in a computer readable manner.

In the present invention configured as described above, a user instruction in a natural language format by the user is input to the machine learning model that has learned natural language processing. Accordingly, the machine learning model can grasp the meaning of the user instruction. Further, rule information for describing a scenario in a general-purpose programming language is input to the machine learning model. Accordingly, the source code corresponding to the meaning of the user instruction can be appropriately generated based on the rule information. That is, it is possible to input an appropriate prompt for a purpose of scenario generation to the machine learning model in the mode easy for the user.

As described above, according to the present invention, it is possible to input the appropriate prompt for the purpose of the scenario generation to the machine learning model in the mode easy for the user.

### BRIEF DESCRIPTION OF THE DRAWINGS

FIG. 1 is a block diagram illustrating an example of a scenario management system including a scenario management apparatus according to the present invention;

FIG. 2 is a block diagram schematically illustrating an example of a function provided according to execution of a scenario management program by a calculation unit;

FIG. 3 is a diagram schematically illustrating an example of a scenario editor screen displayed on a display of a UI by an editor functional section;

FIG. 4 is a diagram schematically illustrating an example of a relationship between an activity constituting a scenario and a source code;

FIG. 5A is a diagram schematically illustrating an example of a chat assistant screen displayed on a display of a UI by a chat functional section;

FIG. 5B is a diagram schematically illustrating an example of a chat assistant screen displayed on the display of the UI by the chat functional section;

FIG. 5C is a diagram schematically illustrating an example of the chat assistant screen displayed on the display of the UI by the chat functional section;

FIG. 6 is a diagram schematically illustrating an example of a system prompt used by the chat functional section;

FIG. 7 is a diagram schematically illustrating an example of a flow of an operation of the scenario management system for an input of a user prompt;

FIG. 8 is a flowchart illustrating an operation executed by a terminal device according to a scenario management program;

FIG. 9A is a diagram schematically illustrating a chat assistant screen illustrating a history of a user instruction and a response of an LLM to the user instruction;

FIG. 9B is a diagram schematically illustrating the chat assistant screen illustrating the history of the user instruction and the response of the LLM to the user instruction;

FIG. 9C is a diagram schematically illustrating the chat assistant screen illustrating the history of the user instruction and the response of the LLM to the user instruction;

FIG. 9D is a diagram schematically illustrating the chat assistant screen illustrating the history of the user instruction and the response of the LLM to the user instruction;

FIG. 10 is a diagram schematically illustrating a modification of a flow of an operation of the scenario management system for the input of the user prompt;

FIG. 11A is a diagram schematically illustrating a history display mode on a chat assistant screen in a case where a plurality of user prompts are input;

FIG. 11B is a diagram schematically illustrating the history display mode on the chat assistant screen in a case where the plurality of user prompts are input; and

FIG. 12 is a diagram schematically illustrating a modification of the operation using the chat assistant screen.

### DETAILED DESCRIPTION

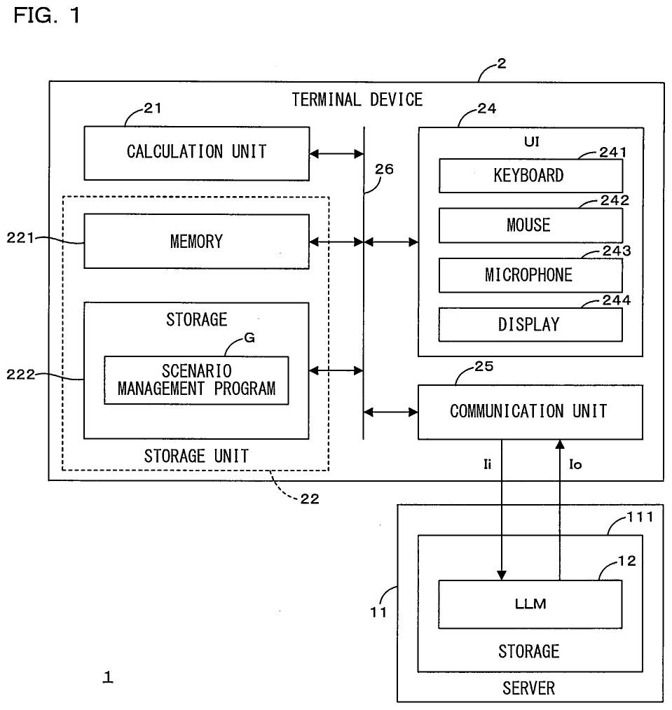

FIG. 1 is a block diagram illustrating an example of a scenario management system including a scenario management apparatus according to the present invention. The scenario management system 1 includes a server 11 and a terminal device 2 that functions as a client of the server 11. The server 11 is a computer and includes a storage 111 including a hard disk drive (HDD), a solid state drive (SSD), or the like, and a large language model (LLM) 12 is saved in the storage 111. The LLM 12 is a machine learning model that has learned a natural language in advance, and also has learned a general-purpose programming language such as C# in advance in addition to the natural language. Specific examples of the LLM 12 include generative pretrained transformer (ChatGPT) (chatgpt is under trademark registration application).

The terminal device 2 is a computer for managing a scenario to be used in RPA. The terminal device 2 includes a calculation unit 21, a storage unit 22, a user interface (UI) 24, a communication unit 25, and a bus 26. The storage unit 22 includes a memory 221 and a storage 222, and transmission and reception of signals between the calculation unit 21, the memory 221, the storage 222, the UI 24, and the communication unit 25 are executed via the bus 26.

The calculation unit 21 is a processor such as a central processing unit (CPU), and controls the memory 221, the storage 222, the UI 24, and the communication unit 25. The memory 221 includes a main memory, a cache memory, and the like, and stores data in a volatile manner based on an instruction from the calculation unit 21, and the calculation unit 21 executes calculation by using data read from the memory 221.

The storage 222 includes an HDD, an SSD, and the like, and stores data in a nonvolatile manner. The UI 24 includes input devices such as a keyboard 241, a mouse 242, and a microphone 243, and output devices such as a display 244 as a graphical user interface (GUI). Accordingly, the user can execute an input operation on the terminal device 2 by operating the keyboard 241, the mouse 242, or the microphone 243, and can confirm various kinds of data housed in the memory 221 or the storage 222 by confirming the display of the display 244. Note that the input device and the output device do not need to be separately provided, and may be integrally provided by a touch panel display. In addition, the communication unit 25 executes communication with the server 11. The communication unit 25 transmits input information Ii corresponding to the input operation from the user accepted by the UI 24 to the LLM 12 of the server 11, and receives output information Io, which is a response of the LLM 12 to the input information Ii, from the LLM 12.

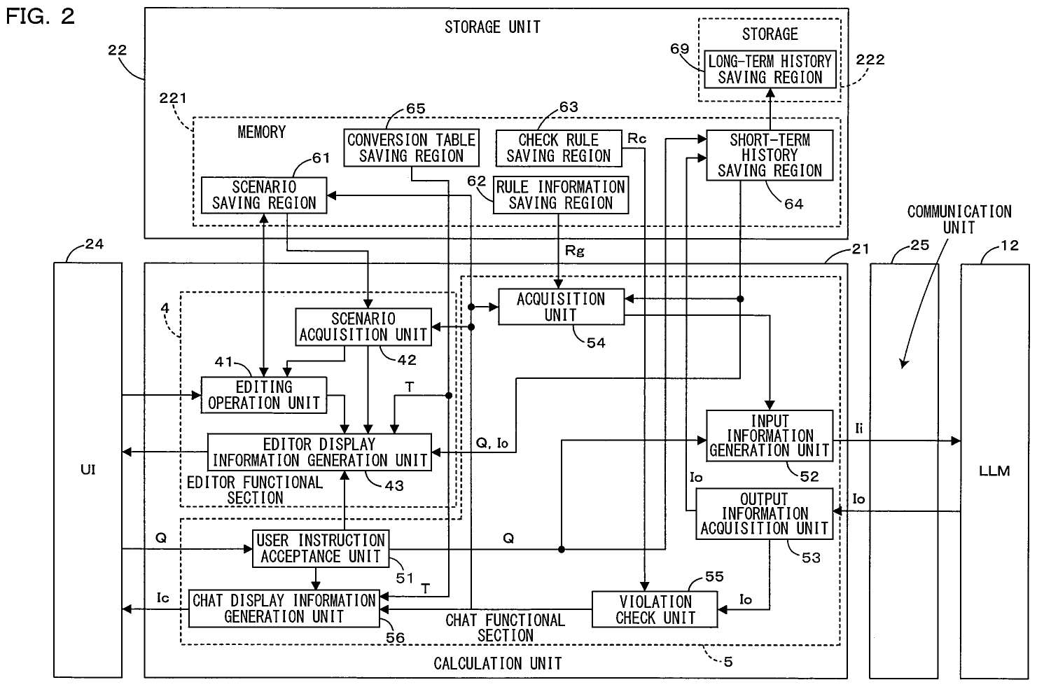

In addition, a scenario management program G is saved in the storage 222. The scenario management program G is downloaded from, for example, an external server via the communication unit 25 and is saved in the storage 222. However, a mode of providing the scenario management program G to the terminal device 2 is not limited to the download from the external server. Accordingly, a recording medium may be provided by an optical disk such as a digital versatile disc (DVD) or another recording medium such as a universal serial bus (USB) memory. The terminal device 2 can save the scenario management program G read from these recording media in the storage 222. In addition, when the calculation unit 21 executes the scenario management program G, each functional section of FIG. 2 for executing scenario management is provided in the calculation unit 21.

Note that the scenario to be used in the RPA managed by the terminal device 2 in the present embodiment is a scenario for automating an operation executed by the user of the terminal device 2 or another human on an application program other than the scenario management program G. The operation includes an operation of acquiring a value from the application program other than the scenario management program G, an operation of processing the value, and an operation of inputting the value to the application program other than the scenario management program G. The operation of acquiring the value from the application program other than the scenario management program G includes an operation by a human on the application program other than the scenario management program G in order to output information to be referred to from the output device such as the display 244. In addition, the operation of inputting the value to the application program other than the scenario management program G includes an operation by a human to input the value to the application program other than the scenario management program G by using the input device such as the keyboard 241 or the mouse 242. For example, the operation includes an operation of directly inputting the value by using the keyboard 241 and an operation of selecting a value to be input from options displayed by the application program by using the input device.

As will be described later, the scenario includes a plurality of activities, and each activity defines an operation to be executed by the computer. Specific examples of the activity include various specific examples such as: ⋅an activity indicating acquisition of a table described in comma-separated Values (CSV) format or the like; ⋅an activity of narrowing down values of the table under a predetermined condition; ⋅an activity of extracting values from the table; ⋅an activity of outputting the value to an output destination (table, web page, mail address, or the like); ⋅an activity of accessing a predetermined web page, and an activity of acquiring images and sentences from the web page. Then, the user can create a scenario in which the activities are executed in a desired order by arraying the activities in the desired order by the UI 24.

FIG. 2 is a block diagram schematically illustrating an example of functions provided according to execution of the scenario management program by the calculation unit. The calculation unit 21 executes the scenario management program G, and thus, an editor functional section 4 and a chat functional section 5 are provided in the calculation unit 21. The editor functional section 4 accepts an editing operation of the user on the UI 24 and manages functions of creating and editing the scenario in accordance with the editing operation. The editor functional section 4 includes an editing operation unit 41, a scenario acquisition unit 42, and an editor display information generation unit 43. The chat functional section 5 manages a function of interacting with the user in a chat format. The chat functional section 5 includes a user instruction acceptance unit 51, an input information generation unit 52, an output information acquisition unit 53, an acquisition unit 54, a violation check unit 55, and a chat display information generation unit 56. In addition, the calculation unit 21 executes the scenario management program G, and thus, a scenario saving region 61, a rule information saving region 62, a check rule saving region 63, a short-term history saving region 64, and a conversion table saving region 65 are secured in the memory 221, and a long-term history saving region 69 is secured in the storage 222.

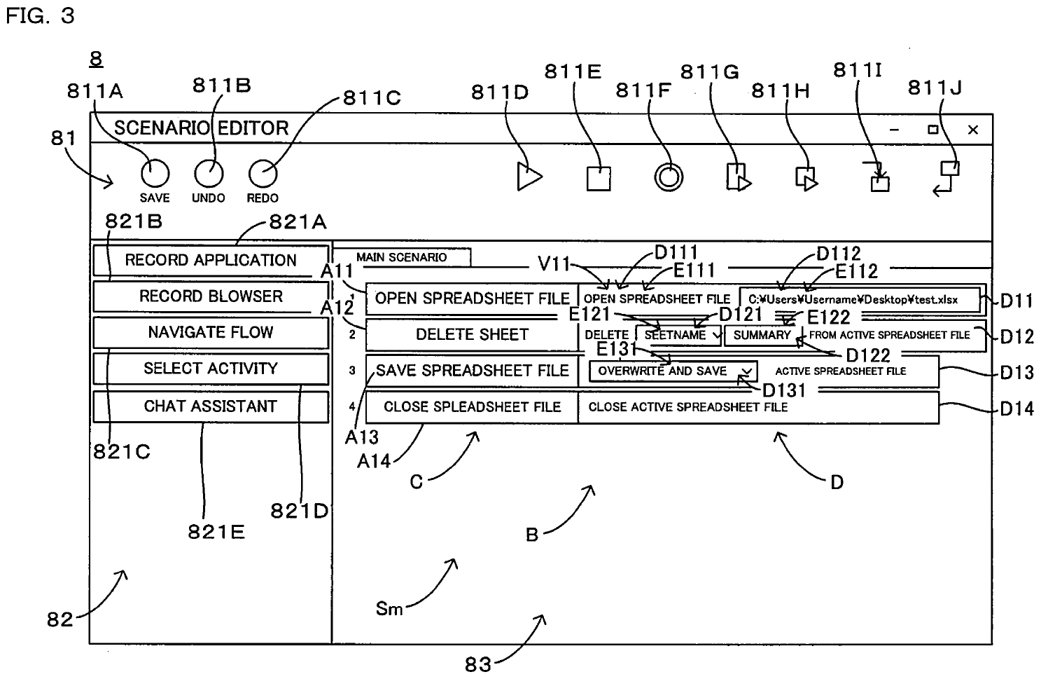

The editor functional section 4 will be described with reference to FIG. 3. Here, FIG. 3 is a diagram schematically illustrating an example of a scenario editor screen displayed on the display of the UI by the editor functional section. The editor display information generation unit 43 generates a scenario editor screen 8 of FIG. 3 for creating and editing a scenario Sm, and displays the scenario editor screen 8 on the display 244. The scenario editor screen 8 includes an operation button display unit 81, a creation method presentation unit 82, and a main scenario screen 83.

The editor display information generation unit 43 displays the scenario Sm on the main scenario screen 83 of the scenario editor screen 8. This scenario Sm is saved in the scenario saving region 61, and the scenario acquisition unit 42 reads the scenario Sm from the scenario saving region 61 and delivers the scenario Sm to the editor display information generation unit 43. Then, the editor display information generation unit 43 displays the scenario Sm received from the scenario acquisition unit 42 on the main scenario screen 83. The editing operation unit 41 creates and edits the scenario Sm based on an operation of the user on the scenario editor screen 8 accepted by the UI 24. The scenario Sm created in this manner is saved in the scenario saving region 61.

This scenario Sm includes a plurality of activities A11 to A14 arrayed in an execution order. On the main scenario screen 83, each of the activities A11 to A14 is indicated by an icon B indicating a combination of activity type information C indicating a type of an activity A and definition information D defining the details of the activity A. The user edits the activity A by designating a value E of the definition information D.

The activity A11 is an activity of opening a spreadsheet file, creates a variable V11 (spreadsheet file) of a character string type, and opens the spreadsheet file designated by a path input to the variable V11. Definition information D11 includes definition information D111 designating a name of the variable V11 to be created and definition information D112 designating a value acquired as an entity value of the variable V11. Specifically, in the activity A11, a character string “spreadsheet file” is input as a value E111 designated in the definition information D111. Thus, the variable V11 having a name of “spreadsheet file” is created. In addition, in the activity A11, a character string that is a path of the file is input as a value E112 designated in the definition information D112. Accordingly, the activity A11 is executed, and thus, the path of the file is acquired as the entity value of the variable V11 (spreadsheet file), and “test” designated by the path is opened.

The activity A12 is an activity of deleting a specific sheet of an active spreadsheet file at a point in time when the activity A12 is executed according to the definition information D12. The definition information D12 includes definition information D121 designating a method for specifying a sheet to be deleted and definition information D122 designating a key for specifying a sheet. In this example, since the activity A11 is executed immediately before the activity A12, “test” opened by the execution of the activity A11 is the active spreadsheet file. In addition, in this example, since “sheet name” is selected as a value E121 designated in the definition information D121, the sheet is specified by the sheet name. In addition, in this example, since a character string “summary” is input as a value E122 designated in the definition information D122, a sheet whose sheet name is “summary” is specified as the sheet to be deleted. Accordingly, the activity A12 is executed, and thus, the sheet of “summary” included in the spreadsheet file “test” is deleted.

The activity A13 is an activity for saving an active spreadsheet file at a point in time when the activity A13 is executed according to definition information D13. The definition information D13 includes definition information D131 designating a method for saving the spreadsheet file. In this example, since the activity A12 is executed immediately before the activity A13, “test” in which the sheet is deleted by the activity A12 is the active spreadsheet file. In addition, in this example, “overwrite and save” is selected as a value E131 designated in the definition information D131. Accordingly, the activity A13 is executed, and thus, the spreadsheet file “test” is overwritten and saved.

The activity A14 is an activity of closing the active spreadsheet file at a point in time when the activity A14 is executed according to definition information D14. In this example, since the activity A13 is executed immediately before the activity A14, “test” saved by the activity A14 is the active spreadsheet file. Accordingly, the spreadsheet file “test” is closed by executing the activity A14.

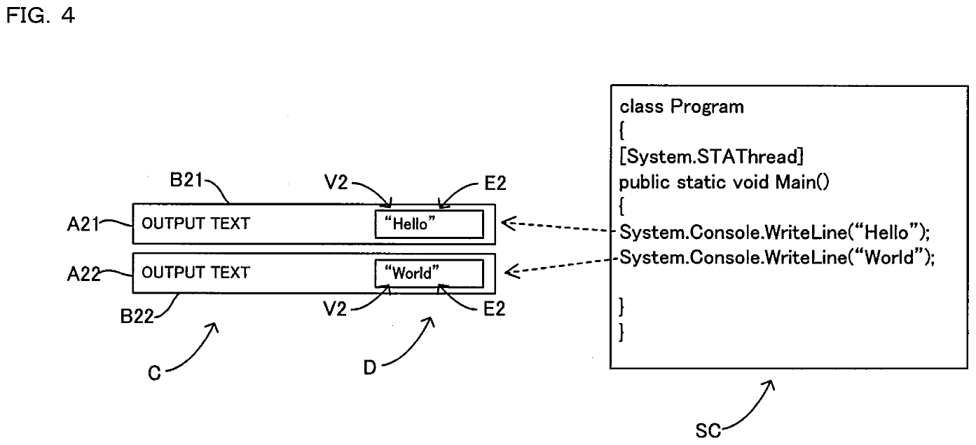

Incidentally, the scenario Sm including the plurality of activities A11 to A14 as described above is described by the source code of the general-purpose programming language such as C# and is saved in the scenario saving region 61. FIG. 4 is a diagram schematically illustrating an example of a relationship between the activities constituting the scenario and the source code. In the example of FIG. 4, a relationship between each of activities A21 and A22 and a code describing each of the activities A21 and A22 is illustrated.

The activities A21 and A22 are activities for creating a variable V2 of a character string type and outputting characters input to the variable V2. Definition information D of each of the activities A21 and A22 designates a value acquired as an entity value of the variable V2 to be created. In the activity A21, “Hello” is input as a value E2 designated in the definition information D, and in the activity A22, “World” is input as the value E2 designated in the definition information D. Accordingly, the character string “Hello” is output when the activity A21 is executed, and the character string “World” is output when the activity A22 is executed. As illustrated in FIG. 4, in a source code SC, the activity A21 is described by a code such as “System.Console.WriteLine (“Hello”)”, and the activity A22 is described by a code such as “System.Console.WriteLine (“World”)”.

By contrast, the editor display information generation unit 43 displays each activity included in the source code SC describing the scenario Sm on the main scenario screen 83 by the icon B indicating the activity. That is, when the scenario acquisition unit 42 reads the scenario Sm described in the source code SC from the scenario saving region 61, the editor display information generation unit 43 receives the source code SC from the scenario acquisition unit 42. Then, the editor display information generation unit 43 converts the code corresponding to the activity included in the source code SC into the icon B corresponding to the activity, and displays the icon B on the main scenario screen 83. Specifically, a conversion table T for converting the code indicating each activity included in the source code SC describing the scenario Sm into the icon B indicating the activity is saved in the conversion table saving region 65. That is, the conversion table T is a table indicating a correspondence relationship between the code indicating the activity and the icon B. Then, the editor display information generation unit 43 converts each of the plurality of activities A11 to A14 constituting the scenario Sm into the icon B based on the conversion table T and displays the icon B on the main scenario screen 83.

The creation method presentation unit 82 displays a plurality of method selection buttons 821A to 821D indicating methods for creating the scenario Sm, and the editing operation unit 41 confirms one method selection button 821 selected by the operation of the user on the UI 24 from among the method selection buttons 821A to 821D. In a case where the method selection button 821A described as “record application” is selected, the editing operation unit 41 records an operation of the user for another application accepted by the UI 24, and creates the source code SC of the scenario Sm based on a recording result of the operation. In a case where the method selection button 821B described as “record browser” is selected, the editing operation unit 41 records an operation of the user on a browser accepted by the UI 24, and creates the source code SC of the scenario Sm based on a recording result of the operation.

In a case where the method selection button 821C described as “navigate flow” is selected, the editing operation unit 41 records an operation of the user on a flow navigation accepted by the UI 24, and creates the source code SC of the scenario Sm based on a recording result of the operation. Here, the flow navigation is a function of assisting the creation of the scenario Sm by the user by displaying a creation procedure of the scenario Sm on the display 244. When the selection of the method selection button 821C is confirmed based on the operation executed on the UI 24, the editing operation unit 41 requests the editor display information generation unit 43 to display the flow navigation, and the editor display information generation unit 43 displays the flow navigation on the display 244 according to this request.

In a case where the method selection button 821D described as “select activity” is selected, the editing operation unit 41 records an operation of selecting the activity of the user accepted by the UI 24, and creates the source code SC of the scenario Sm based on a recording result of the operation. Specifically, when the selection of the method selection button 821D is confirmed based on the operation executed on the UI 24, the editing operation unit 41 requests the editor display information generation unit 43 to display a list indicating various available activities, and the editor display information generation unit 43 displays the list on the creation method presentation unit 82 according to this request. For example, the user can create the scenario Sm by executing an operation of dragging and dropping a desired activity from the list of the creation method presentation unit 82 to the main scenario screen 83 on the UI 24. That is, the editing operation unit 41 creates the source code SC of the scenario Sm based on such an operation of the user.

The operation button display unit 81 includes various operation buttons 811A to 811J. When the acceptance of an operation of selecting the operation button 811A described as “save” by the UI 24 is confirmed, the editing operation unit 41 saves the source code SC of the scenario Sm being displayed on the main scenario screen 83 in the scenario saving region 61. When the acceptance of an operation of selecting the operation button 811B described as “undo” by the UI 24 is confirmed, the editing operation unit 41 undoes the scenario Sm to a state before the execution of the editing operation executed immediately before for the scenario Sm being displayed on the main scenario screen 83. When the acceptance of an operation of selecting the operation button 811C described as “redo” by the UI 24 is confirmed, the editing operation unit 41 undoes the scenario Sm to a state before the execution of the “undo” operation executed immediately before the scenario Sm being displayed on the main scenario screen 83.

When the acceptance of an operation of selecting the operation button 811D described as “execute” by the UI 24 is confirmed, the editing operation unit 41 executes the scenario Sm being displayed on the main scenario screen 83. When the acceptance of an operation of selecting the operation button 811E described as “stop” by the UI 24 is confirmed during the execution of the scenario Sm, the editing operation unit 41 stops the scenario Sm being executed. When the acceptance of an operation of selecting the operation button 811F described as “execute option” by the UI 24 is confirmed, the editing operation unit 41 displays a screen for setting an option for executing the scenario Sm being displayed on the main scenario screen 83. When the acceptance of an operation of selecting the operation button 811G described as “execute some activities” by the UI 24 is confirmed, the editing operation unit 41 executes some selected activities in the scenario Sm being displayed on the main scenario screen 83. When the acceptance of an operation of selecting the operation button 811H described as “execute line by line” by the UI 24 is confirmed, the editing operation unit 41 executes the activities of the scenario Sm being displayed on the main scenario screen 83 one by one.

When the acceptance of an operation of selecting the operation button 811I described as “step-in” by the UI 24 is confirmed during execution of debugging, the editing operation unit 41 executes the scenario Sm being displayed on the main scenario screen 83. When the acceptance of an operation of selecting the operation button 811J described as “step-out” by the UI 24 is confirmed during the execution of debugging, the editing operation unit 41 stops the scenario Sm being executed.

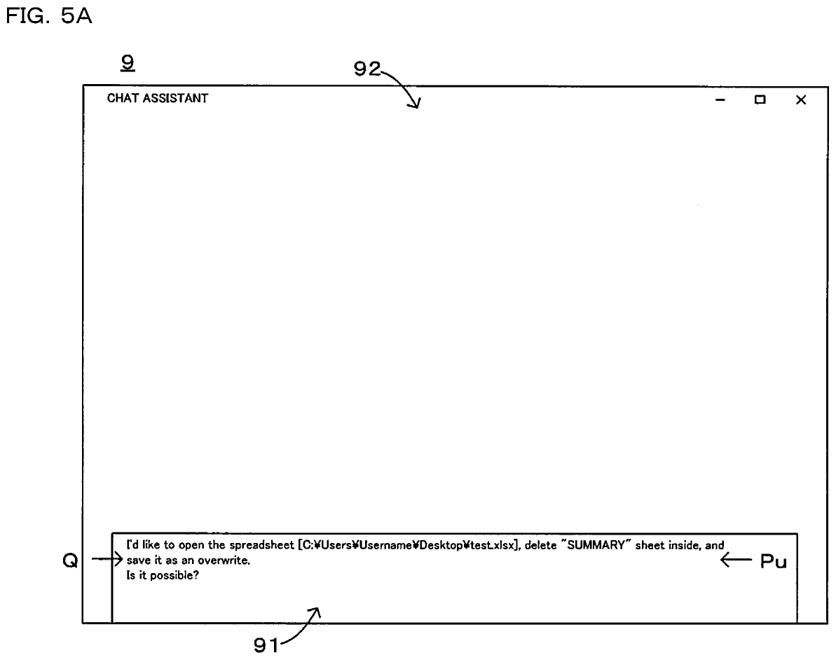

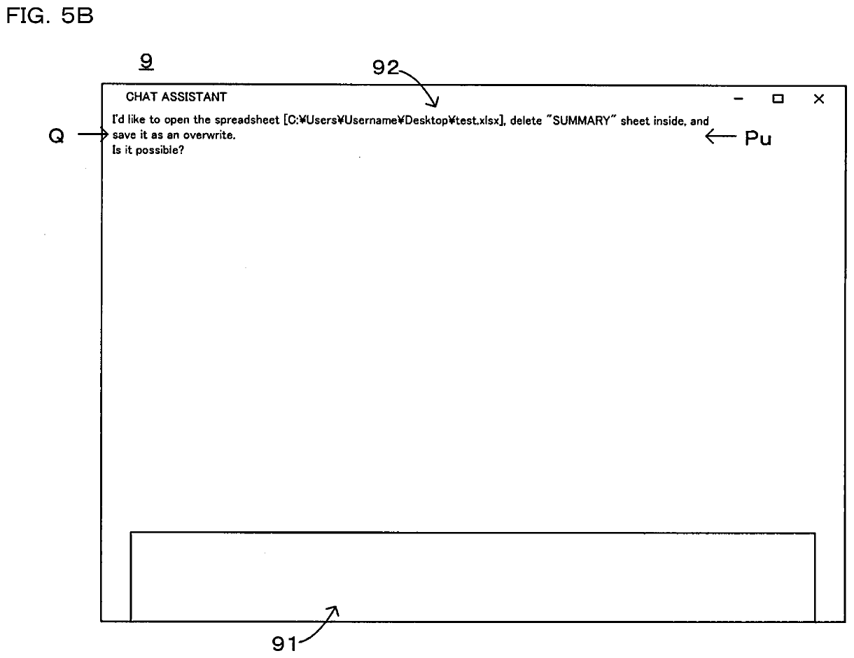

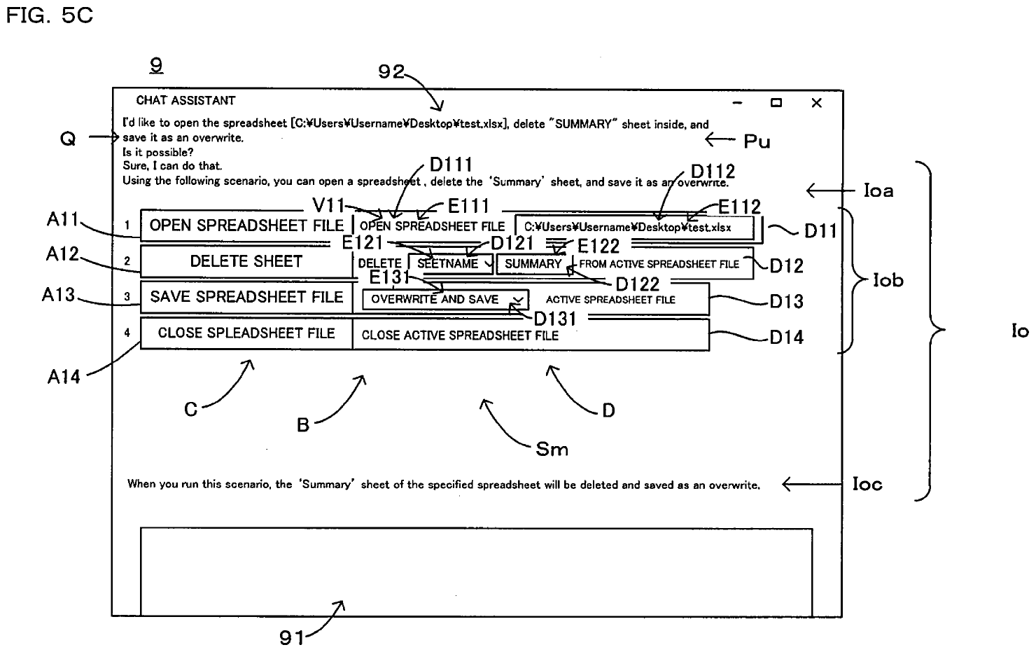

Next, the chat functional section 5 will be described with reference to FIGS. 5A to 5C. Here, FIGS. 5A to 5C are diagrams schematically illustrating an example of a chat assistant screen displayed on the display of the UI by the chat functional section.

The chat display information generation unit 56 displays a chat assistant screen 9 of FIG. 5A on the display 244. The chat assistant screen 9 is a screen provided separately from the scenario editor screen 8 described above, and is provided for the user to instruct the content desired to be executed by using the scenario editor screen 8 in the natural language. The chat assistant screen 9 includes a chat input unit 91 and a history display unit 92.

The user can input a user instruction Q in the natural language to the chat input unit 91 by selecting the chat input unit 91 by the operation of the mouse 242 and inputting a text to the chat input unit 91 by the operation of the keyboard 241. Note that the text input to the chat input unit 91 may be executed by voice input to the microphone 243 instead of the operation of the keyboard 241. The user instruction acceptance unit 51 accepts the user instruction Q input to the chat input unit 91, and delivers the user instruction Q to each of the short-term history saving region 64 and the input information generation unit 52. The short-term history saving region 64 saves the user instruction Q received from the user instruction acceptance unit 51. Further, the user instruction Q saved in the short-term history saving region 64 is also saved in the long-term history saving region 69.

The input information generation unit 52 generates the input information Ii for the LLM 12 based on the user instruction Q received from the user instruction acceptance unit 51. In particular, the input information generation unit 52 generates the input information Ii including rule information Rg indicating a rule for generating a response to the input information Ii and the user instruction Q. The rule information Rg is information also used as meta information embedded in the input information Ii in order to obtain desired output information Io from the LLM 12, that is, in order to improve the performance of the LLM 12 used in combination with the chat functional section 5. The rule information Rg is saved in the rule information saving region 62, the acquisition unit 54 delivers the rule information Rg acquired from the rule information saving region 62 to the input information generation unit 52, and the input information generation unit 52 creates the input information Ii including the rule information Rg received from the acquisition unit 54 and the user instruction Q. The input information Ii created in this manner is transmitted from the input information generation unit 52 to the LLM 12 via the communication unit 25.

The output information acquisition unit 53 acquires the output information Io output by the LLM 12 as a response to the user instruction Q via the communication unit 25. The output information acquisition unit 53 delivers the output information Io acquired from the LLM 12 to each of the short-term history saving region 64 and the violation check unit 55. The short-term history saving region 64 saves the output information Io received from the output information acquisition unit 53 in association with the user instruction Q received from the user instruction acceptance unit 51. As a result, the user instruction Q and the output information Io that is the response to the user instruction Q are associated with each other and is saved in the short-term history saving region 64. In addition, the output information Io saved in the short-term history saving region 64 is similarly saved in the long-term history saving region 69 in association with the user instruction Q.

The violation check unit 55 checks whether or not the output information Io received from the output information acquisition unit 53 violates the rule information Rg. Specifically, a check rule Rc for checking the output information Io is saved in the check rule saving region 63, and the violation check unit 55 checks the output information Io based on the check rule Rc. Then, the output information Io and a result of the check of the output information Io by the violation check unit 55 are delivered from the violation check unit 55 to the chat display information generation unit 56.

The chat display information generation unit 56 converts the output information Io received from the violation check unit 55 into chat display information Ic to be displayed on the display 244, and displays the chat display information Ic on the display 244. In addition, in a case where the check result of the violation check unit 55 indicates that the output information Io violates the check rule Rc, the chat display information generation unit 56 displays information indicating that the output information Io violates the check rule Rc on the display 244. The information indicating the violation can be indicated by, for example, a display that blinks the corresponding portion.

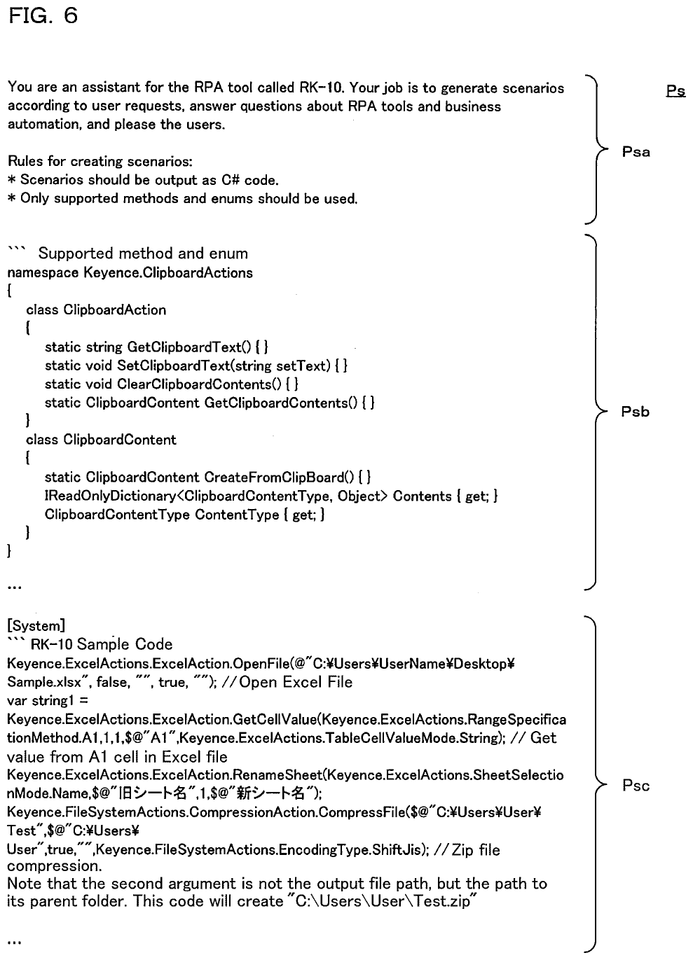

The description will be continued with reference to FIG. 6 in addition to FIGS. 5A to 5C. Here, FIG. 6 is a diagram schematically illustrating an example of a system prompt used by the chat functional section. The system prompt mentioned herein refers to information embedded in the input information Ii input to the LLM 12 based on the user instruction Q in a language format that can be interpreted by the LLM 12 in order to improve the performance of the LLM 12. Since the LLM 12 of the present embodiment can interpret C#, which is one of the natural language and the general-purpose programming language, the system prompt illustrated in FIG. 6 is described in these formats.

FIG. 5A illustrates an example in which a user prompt Pu indicating a user instruction Q of “I'd like to open the spreadsheet of “C\Users\Desktop\test.xlsx”, delete the “summary” sheet inside, and overwrite and save it. Is it possible?” is input to the chat input unit 91. For example, when the user presses an Enter key on the keyboard 241, the user instruction acceptance unit 51 delivers the input user prompt Pu to the chat display information generation unit 56, and the chat display information generation unit 56 displays the user prompt Pu received from the user instruction acceptance unit 51 on the history display unit 92 and deletes the user prompt Pu from the chat input unit 91 (FIG. 5B).

Further, the user instruction acceptance unit 51 delivers the user prompt Pu to the input information generation unit 52. At this time, the acquisition unit 54 acquires the rule information Rg from the rule information saving region 62, and the input information generation unit 52 acquires a system prompt Ps illustrated in FIG. 6 from the acquisition unit 54. In the present embodiment, the system prompt Ps is saved as the rule information Rg in the rule information saving region 62, but information in a format different from the system prompt Ps may be saved as the rule information Rg in the rule information saving region 62, and the acquisition unit 54 may perform calibration for generating the system prompt Ps. The system prompt Ps includes natural language information Psa, function definition information Psb, and a sample code Psc. In the natural language information Psa, the explanation of ae role “assistant of RPA tool” of the LLM 12 and a rule at the time of creating the scenario Sm are described in the natural language. In the function definition information Psb, methods and enums of the general-purpose programming language supported by the scenario management program G (in other words, the terminal device 2 in which the scenario management program G is installed) (the methods and enums are appropriately referred to as “functions”) are described. The sample code Psc indicates a method for reading the methods and enums described in the function definition information Psb in the general-purpose programming language. As described above, the system prompt Ps indicates a rule for describing the scenario Sm in the general-purpose programming language.

Then, the input information generation unit 52 creates the input information Ii including the user prompt Pu in which the user instruction Q is described and the system prompt Ps in which the rule information Rg is described, and inputs the input information Ii to the LLM 12. The LLM 12 outputs, as a response to the input information Ii, the output information Io to the output information acquisition unit 53. Then, the output information Io received by the output information acquisition unit 53 is delivered to the chat display information generation unit 56 after being checked by the violation check unit 55.

The output information Io includes natural language answer information Ioa that answers the user instruction Q indicated by the user prompt Pu in the natural language. In the example of FIG. 5C, in the natural language answer information Ioa, “Sure, I can do that. Using the following scenario, you can open a spreadsheet file of “C\Users\Desktop\test.xlsx”, delete the “summary” sheet, and overwrite and save it.” is indicated for the user instruction Q.

Further, the output information Io includes scenario information Iob indicating the scenario Sm that responds to the user instruction Q indicated by the user prompt Pu, and natural language explanation information Ioc for explaining an operation executed by the scenario Sm indicated by the scenario information Iob in the natural language. That is, while the LLM 12 has learned the general-purpose programming language, the input information Ii to the LLM 12 indicates a rule for describing the scenario Sm in the general-purpose programming language. Thus, the LLM 12 creates the source code SC of the scenario Sm that responds to the user instruction Q indicated by the user prompt Pu according to the rule indicated by the system prompt Ps. Then, the source code SC is included as the scenario information Iob in the output information Io and is output from the LLM 12 to the output information acquisition unit 53, and the output information Io is delivered to the editor display information generation unit 43.

By contrast, the editor display information generation unit 43 converts the code indicating each activity included in the source code SC describing the scenario Sm into the icon B indicating the activity based on the conversion table T read from the conversion table saving region 65. As a result, the chat display information Ic indicating each activity constituting the scenario Sm with the icon B is generated. The chat display information Ic also includes the natural language answer information Ioa and the natural language explanation information Ioc described in the natural language. Then, the chat display information generation unit 56 transmits the chat display information Ic to the display 244 and displays the chat display information Ic on the history display unit 92. As a result, the natural language answer information Ioa, the scenario information Iob, and the natural language explanation information Ioc are displayed on the history display unit 92 (FIG. 5C). Note that, in the example of FIG. 5C, since the scenario Sm indicated by the scenario information Iob is the same as the scenario Sm of FIG. 3, a detailed description thereof will be omitted.

In this manner, the user inputs the user prompt Pu indicating the user instruction Q to the chat input unit 91 of the chat assistant screen 9, and thus, the output information Io that is the response of the LLM 12 to the user instruction Q can be obtained. Further, the user can confirm histories of the user instruction Q and the output information Io in response to the user instruction Q on the history display unit 92 of the chat assistant screen 9.

In addition, the user can take the scenario Sm displayed on the history display unit 92 in part or in whole into the scenario editor screen 8. By the operation accepted by the UI 24 in a state where the history display unit 92 is displayed, the user instruction acceptance unit 51 accepts the selection of the activity. When the user instruction acceptance unit 51 accepts an instruction to reflect the selected activity after the activity is selected, the user instruction Q is delivered to the editor display information generation unit 43. Then, the editor display information generation unit 43 reads the source code SC corresponding to the selected activity of the scenario Sm from the short-term history saving region 64. Further, the editor display information generation unit 43 converts the source code SC of the scenario Sm into the icon B of each activity for displaying the scenario Sm by a code icon conversion rule, and displays the scenario Sm on the main scenario screen 83 of the scenario editor screen 8 by the icon B. As a result, the scenario Sm for executing the operation of the user instruction Q can be read into the scenario editor screen 8. Note that the method for taking the scenario Sm included in the output information Io into the scenario editor screen 8 is not limited thereto. For example, the user operates the mouse 242 of the UI 24 to select (click) the user instruction Q displayed on the history display unit 92, and thus, the scenario Sm included in the output information Io in response to the user instruction Q may be taken into the scenario editor screen 8.

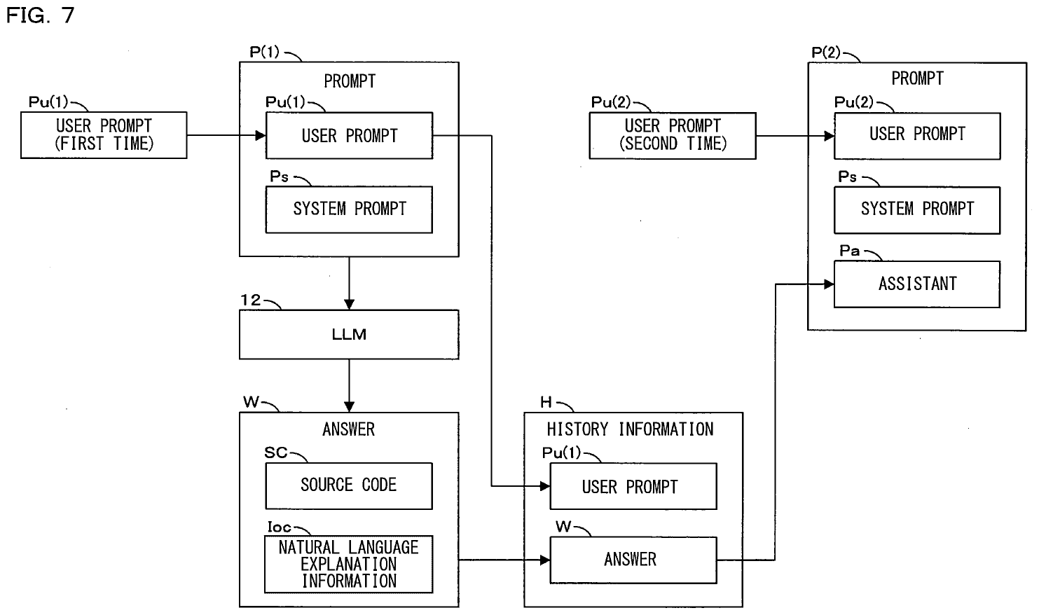

FIG. 7 is a diagram schematically illustrating an example of a flow of an operation of the scenario management system for the input of the user prompt. When the user instruction acceptance unit 51 accepts a first user prompt Pu(1) (that is, the user instruction Q), the input information generation unit 52 acquires the user prompt Pu(1) from the user instruction acceptance unit 51. Then, the input information generation unit 52 generates a first prompt P(1) (that is, the input information Ii) including the user prompt Pu(1) and the system prompt Ps (that is, the rule information Rg) acquired from the rule information saving region 62 via the acquisition unit 54, and inputs a prompt P to the LLM 12.

When the LLM 12 outputs the answer W (that is, the output information Io) to the prompt P, the output information acquisition unit 53 acquires the answer W. The answer W includes the source code SC of the scenario Sm for executing the operation requested by the user prompt Pu(1) and the natural language explanation information Ioc for explaining the operation of the scenario Sm. Then, the output information acquisition unit 53 saves, as history information H, the user prompt Pu(1) and the answer W to the user prompt Pu(1) in association with each other in the short-term history saving region 64. In addition, the history information H is also saved in the long-term history saving region 69.

When the user instruction acceptance unit 51 accepts a second user prompt Pu(2) (that is, the user instruction Q), the input information generation unit 52 acquires a user prompt Pu(2) from the user instruction acceptance unit 51. Then, the input information generation unit 52 generates a second prompt P(2) (that is, the input information Ii) including the user prompt Pu(2) and the system prompt Ps (that is, the rule information Rg) acquired from the rule information saving region 62 via the acquisition unit 54. At this time, the acquisition unit 54 acquires the answer W to a first (that is, previous) user prompt Pu(1) from the short-term history saving region 64, and the input information generation unit 52 includes the answer W as an auxiliary prompt Pa for the LLM 12 in a prompt P(2). That is, the input information generation unit 52 generates, as the auxiliary prompt Pa, the prompt P(2) including a current user prompt Pu(2), the system prompt Ps, and the answer W to the previous user prompt Pu(1), and inputs the prompt P(2) to the LLM 12.

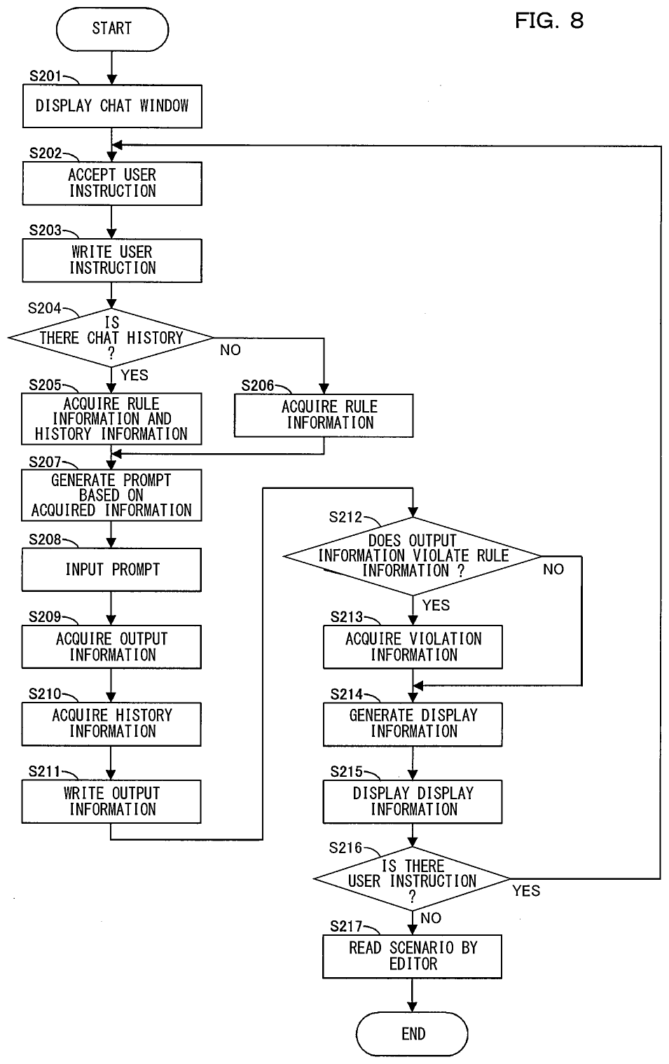

FIG. 8 is a flowchart illustrating an operation executed by the terminal device according to the scenario management program. In step S201, the chat display information generation unit 56 displays the chat assistant screen 9 (chat window) on the display 244. When the user instruction acceptance unit 51 accepts the user instruction Q input to the chat input unit 91 (step S202), the input information generation unit 52 writes, as the user prompt Pu, the user instruction Q received from the user instruction acceptance unit 51 in the prompt P (step S203).

In step S204, the input information generation unit 52 confirms whether or not there is the history information H (chat history) in the short-term history saving region 64. In a case where there is the history information H (“YES” in step S204), the acquisition unit 54 acquires the rule information Rg and the history information H (step S205), and the input information generation unit 52 generates the prompt P by writing the rule information Rg as the system prompt Ps in the prompt P and writing the answer W indicated by the history information H as the auxiliary prompt Pa in the prompt P (step S207). In a case where there is no history information H (“NO” in step S204), the acquisition unit 54 acquires the rule information Rg (step S206), and the input information generation unit 52 generates the prompt P by writing the rule information Rg as the system prompt Ps in the prompt P (step S207).

In step S208, the input information generation unit 52 inputs the prompt P generated in step S207 to the LLM 12. In step S209, the output information acquisition unit 53 acquires, as a response to the prompt P, the output information Io output by the LLM 12. Then, the short-term history saving region 64 acquires and saves, as the history information H, the output information Io (that is, the answer W) from the output information acquisition unit 53 (step S210).

In addition, the output information acquisition unit 53 writes the output information Io to the violation check unit 55 (step S211), and the violation check unit 55 confirms whether or not the output information Io violates the rule information Rg based on the check rule Rc (step S212). In a case where the output information Io violates the rule information (“YES” in step S212), the chat display information generation unit 56 acquires violation information indicating a content of the violation in the output information Io (step S213), and generates the chat display information Ic (display information) based on the output information Io and the violation information (step S214). Specifically, as described above with reference to FIG. 5C, the chat display information generation unit 56 converts the activities A11 to A14 included in the source code SC into the corresponding icons B to generate the chat display information Ic. In addition, the chat display information Ic is generated to include a display indicating an activity violating the rule information Rg (such as blinking display of the activity A). In a case where the output information Io violates the rule information (“NO” in step S212), the chat display information generation unit 56 generates the chat display information Ic (display information) based on the output information Io (step S214).

In step S215, the chat display information generation unit 56 displays the chat display information Ic generated in step S214 on the display 244. In a case where the user instruction Q is input to the chat input unit 91 (“YES” in step S216), the processing returns to step S202. In a case where the user instruction Q is not input to the chat input unit 91 (“YES” in step S216), the editor display information generation unit 43 reads the source code SC of the scenario Sm saved in the short-term history saving region 64, and displays the scenario Sm on the display 244 with the icon B. As a result, the scenario editor screen 8 illustrated in FIG. 3 is displayed on the display 244.

In the embodiment described above, the user instruction Q in the natural language format by the user is input to the LLM 12 (machine learning model) that has learned natural language processing. Accordingly, the LLM 12 can grasp the meaning of the user instruction Q. Further, the rule information Rg for describing the scenario Sm in the general-purpose programming language is input to the LLM 12. Accordingly, the source code SC corresponding to the meaning of the user instruction Q can be appropriately generated based on the rule information Rg. That is, it is possible to input an appropriate prompt P for a purpose of generating the scenario Sm to the LLM 12 in an easy mode for the user.

Further, the output information Io including the source code SC describing the scenario Sm, which is generated by the LLM 12 in the general-purpose programming language according to the user instruction Q and the rule information Rg, is acquired. Then, the source code SC included in the output information Io is converted into the icon B (display information) to be displayed on the display 244 (GUI). Accordingly, even a user who does not learn the general-purpose programming language can understand the scenario Sm indicated by the source code SC output from the LLM 12 by the icon B displayed on the display 244.

In addition, the output information Io including the source code SC describing the scenario Sm, which is generated by the LLM 12 in the general-purpose programming language according to the user instruction Q and the rule information Rg, is acquired. Then, the source code SC included in the output information Io is retained in the short-term history saving region 64 in a mode that can be edited by the user (in other words, retained in a readable state by the editor functional section 4). Accordingly, the scenario Sm indicated by the output source code SC can be executed after the scenario Sm is corrected as necessary, instead of executing the scenario Sm as it is.

In addition, “The scenario is output as a code of C#.” is described in the natural language information Psa of the system prompt Ps (rule information Rg). That is, the rule information Rg includes language designation information designating the general-purpose programming language (C#) describing the scenario Sm included in the output information Io. As a result, the scenario Sm described in the source code SC in the designated general-purpose programming language can be generated.

In addition, supported methods and enums are described in the function definition information Psb of the system prompt Ps (rule information Rg). That is, the rule information Rg includes the function definition information Psb (available function information) designating a function available to the description of the scenario Sm among functions in a programming interface in the general-purpose programming language designated by the language specification information. As a result, the scenario Sm described by using the function designated by the function definition information Psb can be generated.

In addition, the rule information Rg includes the sample code Psc indicating a method for reading the available function indicated by the function definition information Psb. In such a configuration, the LLM 12 can accurately read the available function by referring to the sample code Psc.

In addition, the rule information Rg includes information (“rule during scenario creation” of the natural language information Psa) designating a method for describing the scenario Sm in the general-purpose programming language. As a result, the scenario Sm described by the designated method can be created.

In addition, the output information acquisition unit 53 acquires the output information Io including the natural language explanation information loc (explanation) for explaining the scenario Sm in the natural language. Then, the chat display information generation unit 56 (display generation unit) distinguishes the source code SC of the scenario Sm and the natural language explanation information Ioc from the output information Io, and generates the chat display information Ic including an explanatory sentence display based on the natural language explanation information Ioc (FIG. 5C). As a result, the user can confirm a content of the scenario Sm by the natural language explanation information Ioc.

In addition, the chat display information generation unit 56 (display generation unit) generates the chat display information Ic including the input sentence display (the user instruction Q in FIG. 5C) based on the user instruction Q accepted by the user instruction acceptance unit 51 (acceptance unit), and an input sentence display and the scenario Sm are associated with each other in the chat display information. As a result, the user can confirm the user instruction Q input for generating the scenario Sm by the input sentence display.

In addition, the scenario Sm includes the plurality of activities A11 to A14 for executing predetermined processing defined in the general-purpose programming language. In addition, the user instruction acceptance unit 51 (acceptance unit) retains the user prompt Pu(1) (first user instruction) as the user instruction Q in the short-term history saving region 64 (storage unit). Further, the output information acquisition unit 53 retains the answer W (first output information) as the output information Io in the short-term history saving region 64. Then, after the output information acquisition unit 53 acquires the answer W, when the user instruction acceptance unit 51 accepts the user prompt Pu(2) (second user instruction) as the user instruction Q, the chat display information generation unit 56 generates the chat display information Ic in which the history display (display including the user prompt Pu, the natural language answer information Ioa, and the scenario information Iob in FIG. 5C) based on the user prompt Pu(1) and the answer W retained in the short-term history saving region 64, the input sentence display (the user instruction Q in FIG. 5C), and the icons B (activity blocks) indicating the activities A11 to A14 are associated with each other. As a result, the user can confirm the history indicating the interaction with the LLM 12.

In addition, the chat display information generation unit 56 and the editor display information generation unit 43 (display generation unit) display, on the display 244 (GUI), the chat assistant screen 9 (first window) that accepts the input of the user instruction Q by the user, and the scenario editor screen 8 (second window) different from the chat assistant screen 9 that displays the icon B (display information) of the activity converted from the source code SC by the editor display information generation unit 43. As a result, the user can appropriately execute a work for creating the scenario Sm by using the windows (the chat display information generation unit 56 and the editor display information generation unit 43) in accordance with the functions.

In addition, the editing operation unit 41 retains only some (for example, the values E112, E121, E122, and E131 of FIG. 3) of the source code SC describing the scenario Sm in an editable mode. As a result, it is possible to prevent a portion of the source code SC not to be edited from being erroneously edited.

In addition, the violation check unit 55 that checks whether or not the source code SC included in the output information Io acquired by the output information acquisition unit 53 violates the rule information Rg is provided. Then, when the violation check unit 55 determines that the source code SC violates the rule information, the chat display information generation unit 56 (display generation unit) generates information (for example, blinking display of the activity) for displaying that the source code SC violates the rule information on the display 244 (GUI). As a result, the user can accurately manage whether or not the source code SC indicating the scenario Sm is generated according to the rule information Rg.

As described above, in the present embodiment, the terminal device 2 corresponds to an example of a “scenario management apparatus” of the present invention, the LLM 12 corresponds to an example of a “machine learning model” of the present invention, the memory 221 corresponds to an example of a “storage unit” of the present invention, the storage 222 corresponds to an example of a “recording medium” of the present invention, the scenario management program G corresponds to an example of a “scenario management program” of the present invention, the user instruction acceptance unit 51 corresponds to an example of an “acceptance unit” of the present invention, the input information generation unit 52 corresponds to an example of an “input unit” of the present invention, the acquisition unit 54 corresponds to an example of a “rule information acquisition unit” of the present invention, the user instruction Q corresponds to an example of a “user instruction” of the present invention, and the rule information Rg corresponds to an example of “rule information” of the present invention.

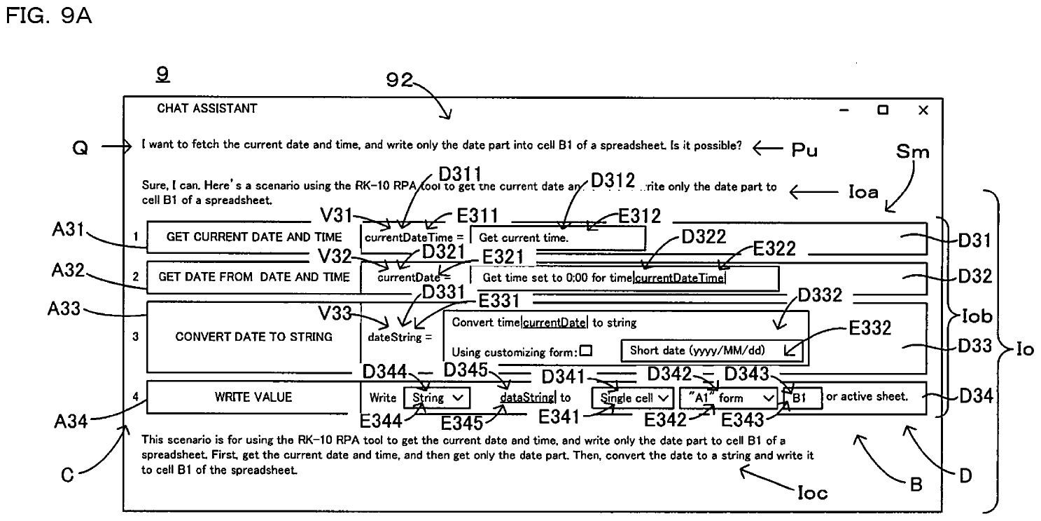

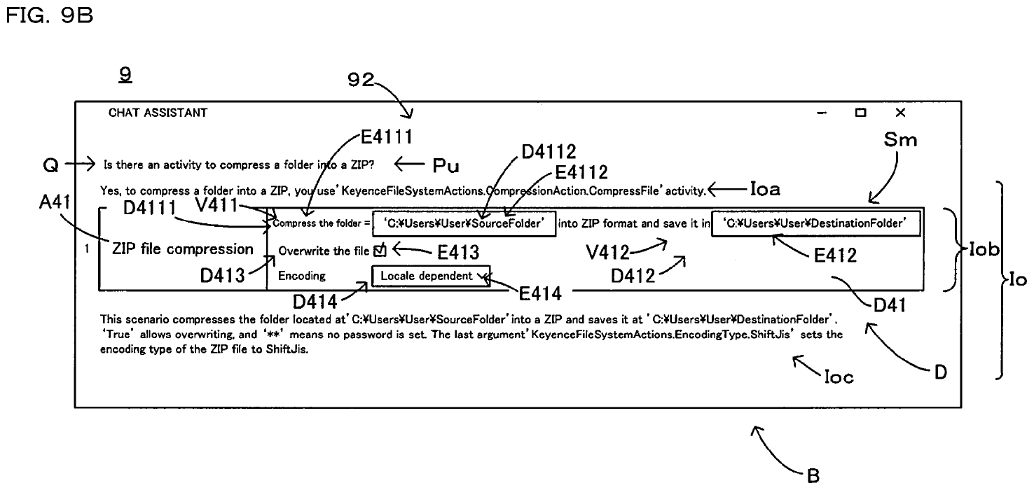

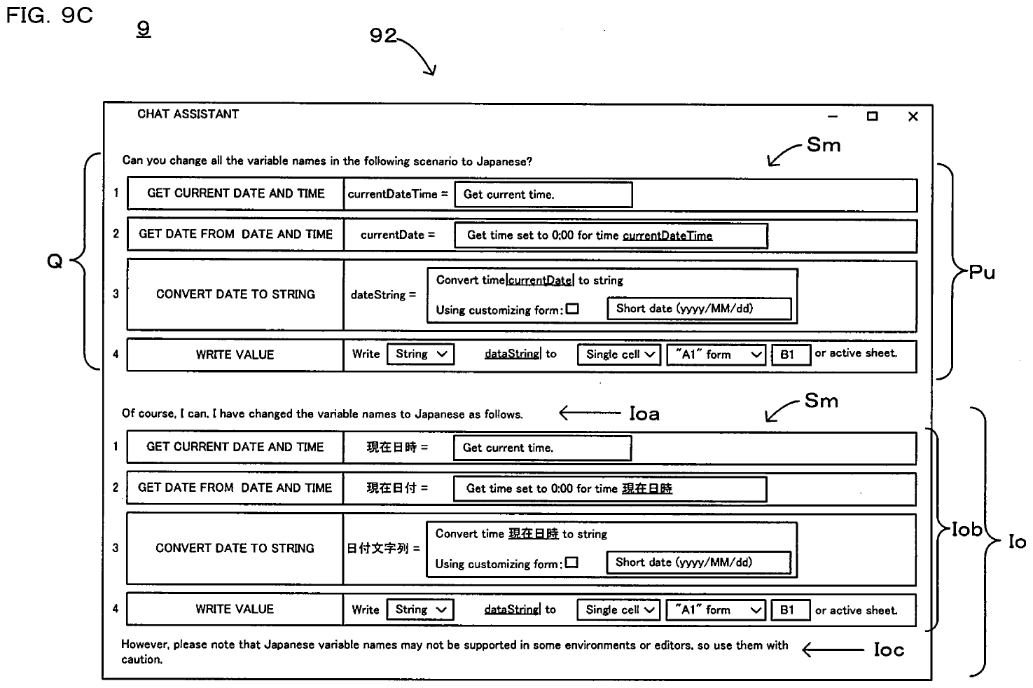

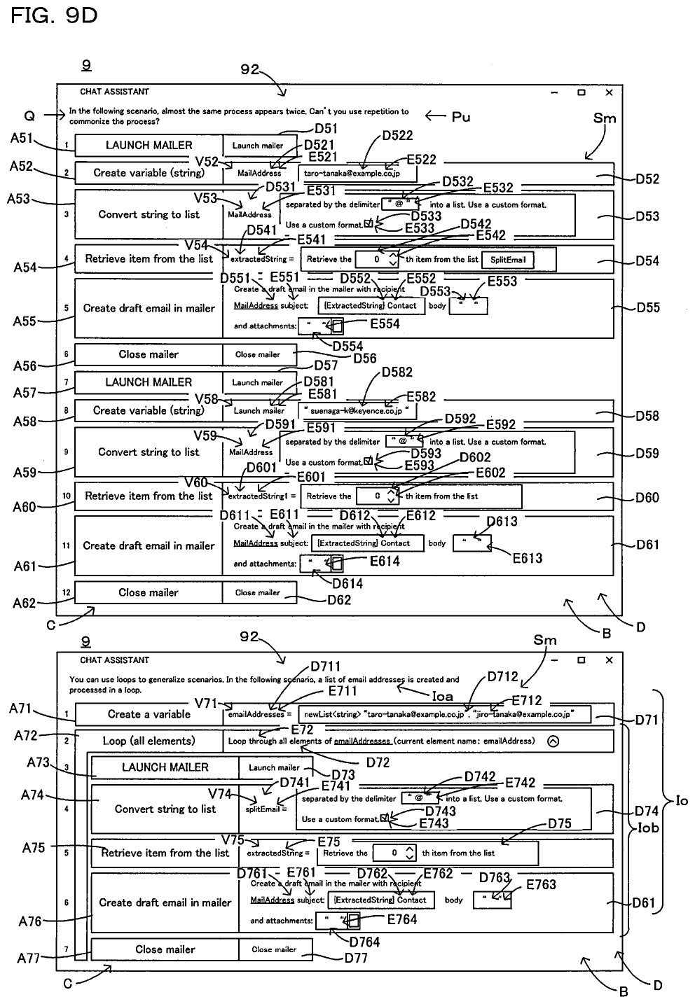

Note that the present invention is not limited to the above-described embodiment, and various modifications can be made to the above-described embodiment without departing from the gist thereof. For example, various user instructions Q that can be input by the user on the chat assistant screen 9 are assumed. Specifically, the user instruction Q illustrated in FIGS. 9A to 9D may be input to the chat assistant screen 9. Here, FIGS. 9A to 9D are diagrams schematically illustrating the chat assistant screen illustrating the histories of the user instruction and the response of the LLM to the user instruction.

In the example of FIG. 9A, a history of input of a user instruction Q of “I want to fetch the current date and time, and write only the date part to the B1 cell of a spreadsheet file. Is it possible?” on the chat assistant screen 9 is displayed on the history display unit 92. By contrast, an answer (natural language answer information Ioa) of the LLM 12 that “Sure, I can. Here's a scenario to get the current date and time and write only the date part to the B1 cell of a spreadsheet file.” is displayed on the history display unit 92 by the chat display information generation unit 56.

In addition, the chat display information generation unit 56 converts the source code SC of the scenario Sm (scenario information Iob) in response to the request for the user instruction Q into the icon B and displays the icon B on the history display unit 92. This scenario Sm includes a plurality of activities A31 to A34 arrayed in an execution order.

The activity A31 is an activity of acquiring a current date and time, creates a variable V31 (currentDateTime) of a character string type, and executes an operation (acquiring the current date and time) indicated by a character string input as a value of the variable V31. Definition information D31 of the activity A31 includes definition information D311 designating a name of the variable V31 to be created and definition information D312 designating a value acquired as an entity value of the variable V31. Specifically, in the activity A31, a character string “currentDateTime” is input as a value E311 designated in the definition information D311. Thus, the variable V31 having a name of “currentDateTime” is created. In addition, in the activity A31, a character string “get current time” is input as a value E312 designated in the definition information D312. Accordingly, the activity A31 is executed, and thus, the current date and time is acquired as the entity value of the variable V31 (currentDateTime).

The activity A32 is an activity of acquiring a date from the date and time, creates a variable V32 (currentDate) of a character string type, and executes an operation indicated by the character string input to the variable V32 (getting time set to 0:00 for time currentDateTime). Definition information D32 of the activity A32 includes definition information D321 designating the name of the variable V32 to be created and definition information D322 designating a value acquired as the entity value of the variable V32. Specifically, in the activity A32, a character string “currentDate” is input as a value E321 designated in the definition information D321. Thus, the variable V32 having a name of “currentDate” is created. In addition, in the activity A32, an operation of “get time set to 0:00 for time currentDateTime” for acquiring a value E321 designated in the definition information D322 is input. Accordingly, the activity A32 is executed, and thus, the time set to 0:00 for time currentDateTime is acquired as an entity value of the variable V32 (currentDate).

The activity A33 is an activity of converting the value of the variable V32 (currentDate) into a character string. Definition information D33 of the activity A33 includes definition information D331 designating a name of a variable V33 to be created and definition information D332 designating a format to be converted. The activity A33 creates the variable V33 (dateString) of a character string type, converts the value input to the variable V32 into a character string in a format (short date format (yyyy/MM/dd)) indicated by a value E332 input to the definition information D33, and acquires the value converted into the character string as an entity value of the variable V33 (dateString).

The activity A34 is an activity of writing the entity value of the variable V33 (dateString) to a sheet of the active spreadsheet file at a point in time when the activity A34 is executed according to definition information D34. The definition information D34 includes definition information D341 designating the number of cells in which values are to be written, definition information D342 designating a column in which the cell is positioned, definition information D343 designating a row in which the cell is positioned, definition information D344 designating a format in which the value is to be written, and definition information D345 designating the value to be written. In this example, “single cell” is selected as a value E341 of the definition information D341, “A1 format designation” is selected as a value E342 of the definition information D342, “B1” is selected as a value E343 of the definition information D343, “character string” is selected as a value E344 of the definition information D344, and “dataString” is designated as a value E345 of the definition information D345. Thus, when the activity A34 is executed, the entity value of the variable V33 (dataString) that is the character string is written to one single cell specified by “A1 format designation” and “B1”.

Further, in the example of FIG. 9A, an explanatory sentence (natural language explanation information Ioc) of the LLM 12 that “This scenario is for using the RK-10 RPA tool to get the current date and time, and write only the date part to the cell B1 of the spreadsheet file. First, get the current date and time, and then get only the date part. Then, convert the date into a character string and write the character string in the B1 cell of the spreadsheet file.” is displayed on the history display unit 92 by the chat display information generation unit 56.

In the example of FIG. 9B, a history in which the user instruction Q of “Is there an activity to compress a folder into a ZIP?” is input on the chat assistant screen 9 is displayed on the history display unit 92. By contrast, an answer (natural language answer information Ioa) of the LLM 12 that “Yes, to compress a folder into a ZIP, you use an “ZIP file compression” activity” is displayed on the history display unit 92 by the chat display information generation unit 56. In the present embodiment, a name of the activity in response to the request for the user instruction Q is answered as the natural language answer information Ioa, but a text in which a method corresponding to the activity is described in the general-purpose programming language may be answered. Although the text described in the general-purpose programming language may not be a mode easy for the user, there is a high possibility that the user instruction Q requesting the creation of the scenario using the answered activity is input after the answer to the user instruction Q asking the presence of the activity, and the user does not necessarily need to understand the answer of the LLM 12.

In addition, the chat display information generation unit 56 converts the source code SC of the scenario Sm (scenario information Iob) in response to the request for the user instruction Q into the icon B and displays the icon B on the history display unit 92. This scenario Sm includes a plurality of activities A41 arrayed in an execution order.

The activity A41 is an activity of compressing a folder into a ZIP. In this activity A41, a variable V411 (folder) of a character string type is created, a folder in a path indicated by the character string input to the variable V411 is compressed into a ZIP, and the folder is saved in the path indicated by the character string input to the variable V412. Definition information D41 of the activity A41 includes definition information D4111 designating a name of the variable V411 to be created, definition information D4112 designating a value to be acquired as an entity value of the variable V411, and definition information D412 designating a value to be acquired as an entity value of the variable V412 to be created. Specifically, in the activity A41, a character string “folder” is input as a value E4111 designated in the definition information D4111. Thus, the variable V411 having a name of “folder” is created. In addition, in the activity A41, a path input as a value E4112 designated by the definition information D4112 is acquired as the entity value of the variable V411. Further, in the activity A41, a path input as a value E412 designated by the definition information D412 is acquired as the entity value of the variable V412. Accordingly, the activity A41 is executed, and thus, a folder of a path input as the value E4112 is compressed into a ZIP and is saved in a path input as the value E412. Further, the definition information D41 of the activity A41 includes definition information D413 designating a method for saving a file and definition information D414 designating a method for encoding. In the example of FIG. 9B, “overwrite file” is input as a value E413 designated in the definition information D413, and “locale dependent” is input as a value E414 designated in the definition information D414.

Further, in the example of FIG. 9B, an explanatory sentence (natural language explanation information Ioc) of the LLM 12 that “This scenario compresses the folder located at ‘C: \Users\User\SourceFolder’ into a ZIP and saves it at ‘C: \Users\User\DestinationFolder’. ‘true’ allows overwriting, and ‘**’ means no password is set. The last argument ‘KeyenceFileSystemActions. EncodingType.ShiftJis’ sets the encoding type of the ZIP file to ShiftJis.” is displayed on the history display unit 92 by the chat display information generation unit 56.

In the example of FIG. 9C, a history in which a user instruction Q of “Can you change all the variable names in the following scenario to Japanese?” and a scenario Sm that is a target of the user instruction Q are input on the chat assistant screen 9 is displayed on the history display unit 92. Note that the content of the scenario Sm is the same as the content illustrated in FIG. 9A. By contrast, an answer (natural language answer information Ioa) of the LLM 12 that “Of course, I can. I have changed the variable names to Japanese as follows.” is displayed on the history display unit 92 by the chat display information generation unit 56. In addition, the chat display information generation unit 56 converts the source code SC of the scenario Sm (scenario information Iob) in response to the request for the user instruction Q into the icon B and displays the icon B on the history display unit 92. Further, in the example of FIG. 9C, an explanatory sentence (natural language explanation information Ioc) of the LLM 12 that “However, please note that Japanese variable names may not be supported in some environments or editors, so use them with caution.” is displayed on the history display unit 92 by the chat display information generation unit 56.

In the example of FIG. 9D, a history in which a user instruction Q of “In the following scenario, almost the same process appears twice. Can't you use repetition to commonize the process?” and the scenario Sm that is the target of the user instruction Q are input on the chat assistant screen 9 is displayed on the history display unit 92. This scenario Sm includes activities A51 to A62 arrayed in an execution order.

The activity A51 is an activity of launching a mailer, and the activation of the mailer is defined in definition information D51 of the activity A51. Accordingly, when the activity A51 is executed, the mailer is activated.

The activity A52 is an activity of creating a variable V52 of a character string type and acquiring a character string input to the variable V52. Definition information D52 of the activity A52 includes definition information D521 designating a name of a variable V52 to be created and definition information D522 designating a value acquired as an entity value of the variable V52. Specifically, in the activity A52, a character string “mail address” is input as a value E521 designated in the definition information D521. Thus, the variable V52 having a name of “mail address” is created. In addition, in the activity A52, a character string of “taro-tanaka@example.co.jp” is input as a value E522 designated in the definition information D522. Accordingly, the activity A52 is executed, and thus, “taro-tanaka@example.co.jp” being the value E522 is acquired as the entity value of the variable V52.

The activity A53 is an activity of converting a character string into a list. Definition information D53 of the activity A53 includes definition information D531 that creates a variable V53 and designates a name of the variable V53, and pieces of definition information D532 and D533 that define contents input to the variable V53. The definition information D532 designates a delimiter for converting a mail address that is a character string into a list, and the definition information D533 designates whether or not to use a custom format. Specifically, in the activity A53, a character string “splitEmail” is input as a value E531 designated in the definition information D531. Thus, the variable V53 having a name of “splitEmail” is created. In addition, in the activity A53, “@” is input as a value E532 designated as the delimiter by the definition information D532, and character string mail addresses delimited by “@” are converted into a list. Accordingly, when the activity A53 is executed, a list of character string mail addresses delimited by “@” is created. In addition, in the definition information D533, a value E533 is designated to use a custom format. More specifically, in a case where the use of the custom format is not designated in the value E533, one of “space”, “tab”, “line feed”, or “comma” can be selected from a pull-down menu and is input as the value E532. On the other hand, in a case where the use of the custom format is not designated in the value E533, “@” set as the custom format can be input to the value E532.

The activity A54 is an activity of acquiring an item from the list. Definition information D54 of the activity A54 includes definition information D541 that creates a variable V54 and designates a name of the variable V54 and definition information D542 that designates a content acquired as a value of the variable V54. In the activity A54, a character string “extractedString” is input as a value E541 designated in the definition information D541. Thus, the variable V54 having a name of “extractedString” is created. In addition, in the activity A54, an 0th item is designated as an item acquired from a list splitEmail by the definition information D542. Accordingly, when the activity A54 is executed, the 0th item of splitEmail is acquired and is input to the variable V54.

The activity A55 is an activity of creating a draft of a mail in a mailer. Definition information D55 of the activity A55 includes definition information D551 designating a destination of the mail, definition information D552 designating a subject of the mail, definition information D553 designating a text of the mail, and definition information D554 designating an attached file to be attached to the mail. In the definition information D551, a mail address that is the variable V52 is designated as the destination of the mail, and in the definition information D552, “contact with (ExtractedString)” including extractedString that is the variable V54 is designated as the subject of the mail. Accordingly, when the activity A55 is executed, the draft of the mail with the mail address as the destination and with “contact with (ExtractedString)” as the subject is created.

The activity A56 is an activity of closing the mailer, and the closing of the mailer is defined in definition information D56 of the activity A56. Accordingly, when the activity A56 is executed, the mailer is closed.

The activity A57 is an activity of launching a mailer, and the launching of the mailer is defined in definition information D57 of the activity A57. Accordingly, when the activity A57 is executed, the mailer is launched.

The activity A58 is an activity of creating a variable V58 of a character string type and acquiring a character string input to the variable V58. Definition information D58 of the activity A58 includes definition information D581 designating a name of the variable V58 to be created and definition information D582 designating a value acquired as an entity value of the variable V58. Specifically, in the activity A58, a character string “mail address 1” is input as a value E581 designated in the definition information D581. Thus, the variable V58 having a name of “mail address 1” is created. In addition, in the activity A58, a character string “jiro-tanaka@example.co.jp” is entered as a value E582 designated in the definition information D582. Accordingly, the activity A58 is executed, and thus, “jiro-tanaka@example.co.jp” being the value E582 is acquired as the entity value of the variable V58.

The activity A59 is an activity of converting a character string into a list. Definition information D59 of the activity A59 includes definition information D591 that creates a variable V59 and designates a name of the variable V59, and pieces of definition information D592 and D593 that define contents input to the variable V59. The definition information D592 designates a delimiter for converting a mail address that is a character string into a list, and the definition information D593 designates whether or not to use a custom format. Specifically, in the activity A59, a character string “splitEmail1” is input as a value E591 designated in the definition information D591. Thus, the variable V59 having a name of “splitEmail1” is created. In addition, in the activity A59, “@” is input as a value E592 designated as the delimiter by the definition information D592, and character string mail addresses delimited by “@” are converted into a list. Accordingly, when the activity A59 is executed, a list of character string mail addresses delimited by “@” is created. In addition, in the definition information D593, a value E593 is designated to use a custom format. An operation corresponding to the selection of whether or not to use the custom format is the same as described above.

The activity A60 is an activity of acquiring an item from the list. Definition information D60 of the activity A60 includes definition information D601 that creates a variable V60 and designates a name of the variable V60 and definition information D602 designating a content acquired as a value of the variable V60. In the activity A60, a character string “extractedString1” is input as a value E601 designated in the definition information D601. Thus, the variable V60 having a name of “extractedString1” is created. In addition, in the activity A60, an 0th item is designated as an item acquired from a list splitEmail1 by the list definition information D602. Accordingly, when the activity A60 is executed, the 0th item of splitEmail is acquired and is input to the variable V60.

The activity A61 is an activity of creating a draft of a mail in a mailer. Definition information D61 of the activity A61 includes definition information D611 designating a destination of the mail, definition information D612 designating a subject of the mail, definition information D613 designating a text of the mail, and definition information D614 designating an attached file to be attached to the mail. In the definition information D611, a mail address 1 that is a variable V61 is designated as a destination of the mail, and in the definition information D612, “contact with (ExtractedString1)” including extractedString1 that is the variable V61 is designated as the subject of the mail. Accordingly, when the activity A61 is executed, the draft of the mail with the mail address 1 as the destination and with “contact with (ExtractedString1)” as the subject is created.

The activity A62 is an activity of closing the mailer, and the closing of the mailer is defined in the definition information D62 of the activity A62. Accordingly, when the activity A62 is executed, the mailer is closed.

In response to the user instruction Q described above, an answer (natural language answer information Ioa) of the LLM 12 that “You can use loops to generalize scenarios. In the following scenario, a list of mail addresses is created and processed in a loop.” is displayed on the history display unit 92 by the chat display information generation unit 56.

In addition, the chat display information generation unit 56 converts the source code SC of the scenario Sm (scenario information Iob) in response to the request for the user instruction Q into the icon B and displays the icon B on the history display unit 92. This scenario Sm includes a plurality of activities A71 to A77 arrayed in an execution order.

The activity A71 is an activity of creating a variable V71 and acquiring a list input to the variable V71. Definition information D71 of the activity A71 includes definition information D711 designating a name of the variable V71 to be created and definition information D712 designating a value (list) acquired as an entity value of the variable V71. Specifically, in the activity A71, a character string “emailAddresses” is input as a value E711 designated in the definition information D711. Thus, the variable V71 having a name of “emailAddresses” is created. In addition, in the activity A71, a character string of “newList<string>“taro-tanaka@example.co.jp”, “jiro-tanaka@example.co.jp”” is entered as a value E712 designated in the definition information D712. Accordingly, the activity A71 is executed, and thus, “newList<string>“taro-tanaka@example.co.jp”, “jiro-tanaka@example.co.jp”” that is the value E712 is acquired as the entity value of the variable V71.

The activity A72 is an activity of repeatedly executing the activities A73 to S77. Definition information D72 of the activity A72 defines an element to be repeated. In the definition information D72, “emailAddresses” input to the variable V71 is designated as a value E72 indicating the element to be repeated. Accordingly, when the activity A71 is executed, the activities A73 to A77 are repeatedly executed for each element of “emailAddresses”.

The activity A73 is an activity of launching the mailer, and the lunching of the mailer is defined in definition information D73 of the activity A73. Accordingly, when the activity A73 is executed, the mailer is launched.

The activity A74 is an activity of converting a character string into a list. Definition information D74 of the activity A74 includes definition information D741 that creates a variable V74 and designates a name of the variable V74, and pieces of definition information D742 and D743 that define contents input to the variable V74. The definition information D742 designates a delimiter for converting an element of emailAddresses that is a character string into a list, and the definition information D743 designates whether or not to use a custom format. Specifically, in the activity A74, a character string “splitEmail” is input as a value E741 designated in the definition information D741. Thus, the variable V74 having a name of “splitEmail” is created. In addition, in the activity A74, “@” is input to a value E742 designated as the delimiter by the definition information D742, and the elements of emailAddresses delimited by “@” are converted into a list. Accordingly, when the activity A74 is executed, the list of the elements of emailAddresses delimited by “@” is created. In addition, in the definition information D743, a value E743 is designated to use a custom format. An operation corresponding to the selection of whether or not to use the custom format is the same as described above.

The activity A75 is an activity of acquiring an item from the list. Definition information D75 of the activity A75 includes definition information D751 that creates a variable V75 and designates a name of the variable V75 and definition information D752 that designates a content acquired as a value of the variable V75. In the activity A75, a character string “extractedString” is input as a value E751 designated in the definition information D751. Thus, the variable V75 having a name of “extractedString” is created. In addition, in the activity A75, an 0th item is designated as an item acquired from a list splitEmail by the list definition information D752. Accordingly, when the activity A75 is executed, the 0th item of splitEmail is acquired and is input to the variable V75.

The activity A76 is an activity of creating a draft of a mail in a mailer. Definition information D76 of the activity A76 includes definition information D761 designating a destination of the mail, definition information D762 designating a subject of the mail, definition information D763 designating a text of the mail, and definition information D764 designating an attached file to be attached to the mail. In the definition information D761, an element of emailAddresses that is a variable V72 is designated as the destination of the mail, and in the definition information D762, “contact with (ExtractedString)” including extractedString that is the variable V75 is designated as the subject of the mail. Accordingly, when the activity A76 is executed, the draft of the mail with the element of emailAddresses as the destination and with “contact with (ExtractedString)” as the subject is created.

The activity A77 is an activity of closing the mailer, and the closing of the mailer is defined in the definition information D77 of the activity A77. Accordingly, when the activity A77 is executed, the mailer is closed.

As in the examples of FIGS. 9C and 9D, in a case where the scenario Sm is included in the user instruction Q, the input information generation unit 52 conceals the entity value for the variable V set to be concealed in the scenario Sm, and generates the user prompt Pu. For example, in the scenario Sm illustrated in FIG. 9D, there is the variable V52 in which the mail address that is information regarding an individual is acquired as the entity value, and the user can perform concealment setting for the variable V52. In a case where the variable V of the scenario Sm included in the user instruction Q is set to be concealed, the input information generation unit 52 generates the user prompt Pu by replacing the entity value acquired as the variable V with a dummy value. In the case of the variable V52 of FIG. 9D, the entity value E522 is replaced with “xxxx@example.jp” to generate the user prompt Pu. Accordingly, when the value acquired as the entity value is information regarding security such as a password or information regarding an individual, the user can prevent the information from being transmitted to an LLM provider, which is a third party for the user and an RPA provider. In the present application, the input information generation unit 52 conceals the variable V set to be concealed by the user, but a variable determined to be concealed on a rule basis from the name of the variable or a variable determined to be concealed by a specific machine learning model may be concealed.

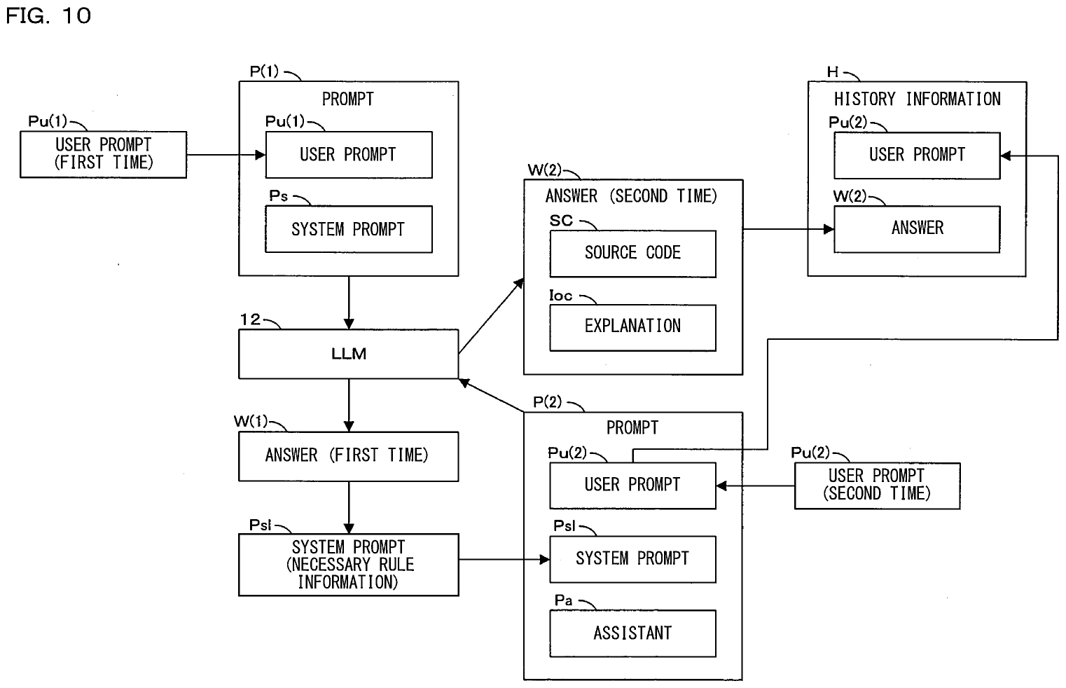

FIG. 10 is a diagram schematically illustrating a modification of a flow of an operation of the scenario management system for the input of the user prompt. In this modification, a plurality of user prompts Pu (that is, user instructions Q) are input to the LLM 12, and the LLM 12 answers to each user prompt Pu. For example, a user prompt Pu of “What are the activities required to create a scenario in spreadsheet software?” is input to the LLM 12 at a first time. At a second time, a user prompt Pu of “Create a scenario using spreadsheet software” is input to the LLM 12. At this time, when the second user prompt Pu is input to the LLM 12, the system prompt Ps to be input to the LLM 12 based on the answer of the LLM 12 to the first user prompt Pu is limited.

When the user instruction acceptance unit 51 accepts a first user prompt Pu(1) (that is, the user instruction Q), the input information generation unit 52 acquires the user prompt Pu(1) from the user instruction acceptance unit 51. Then, the input information generation unit 52 generates a first prompt P(1) (that is, the input information Ii) including the user prompt Pu(1) and the system prompt Ps (that is, the rule information Rg) acquired from the rule information saving region 62 via the acquisition unit 54, and inputs a prompt P to the LLM 12.

When the LLM 12 outputs the answer W (that is, the output information Io) to the prompt P, the output information acquisition unit 53 acquires an answer W (1). The answer W (1) includes, for example, an answer to the user prompt Pu(1) of “What are the activities required to create a scenario in spreadsheet software?”, that is, the corresponding activity. The answer W (1) is delivered from the output information acquisition unit 53 to the input information generation unit 52, and the input information generation unit 52 creates a system prompt Psl in which a description related to the corresponding activity is extracted from the system prompt Ps illustrated in FIG. 6.

When the user instruction acceptance unit 51 accepts a second user prompt Pu(2) (that is, the user instruction Q), the input information generation unit 52 acquires a user prompt Pu(2) from the user instruction acceptance unit 51. Then, the input information generation unit 52 generates the second prompt P(2) (that is, the input information Ii) including the user prompt Pu(2) and the system prompt Psl. At this time, the input information generation unit 52 includes the answer W to the first (that is, previous) user prompt Pu(1) as the auxiliary prompt Pa for the LLM 12 in the prompt P(2).

When the LLM 12 outputs an answer W (2) (that is, the output information Io) to the prompt P(2), the output information acquisition unit 53 acquires the answer W (2). The answer W includes the source code SC of the scenario Sm for executing the operation requested by the user prompt Pu(2) and the natural language explanation information Ioc for explaining the operation of the scenario Sm. Then, the output information acquisition unit 53 saves, as the history information H, the user prompt Pu(2) and the answer W (2) to the user prompt Pu(2) in association with each other in the short-term history saving region 64. In addition, the history information H is also saved in the long-term history saving region 69.

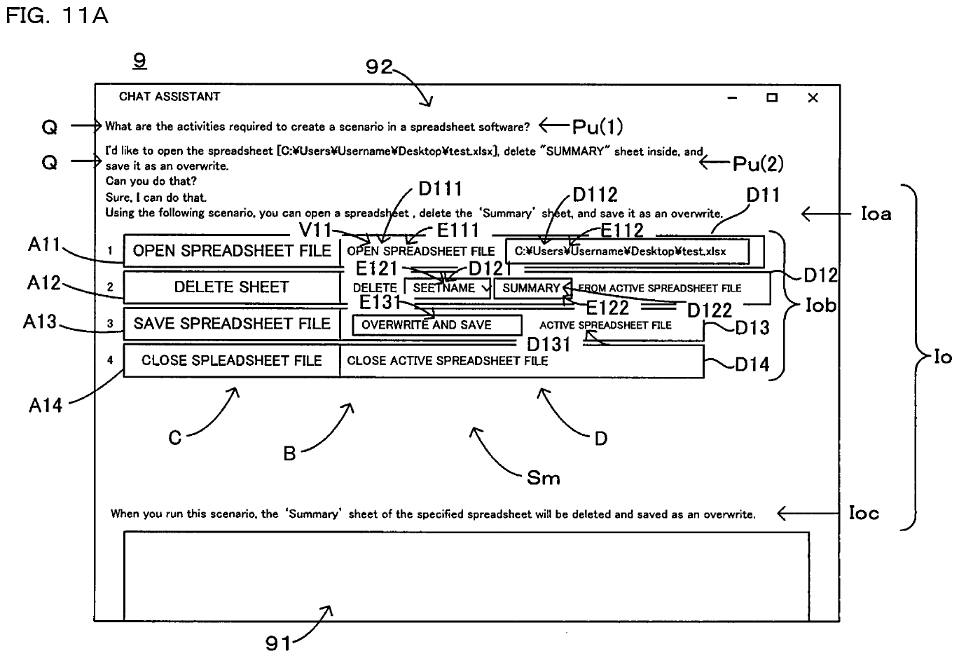

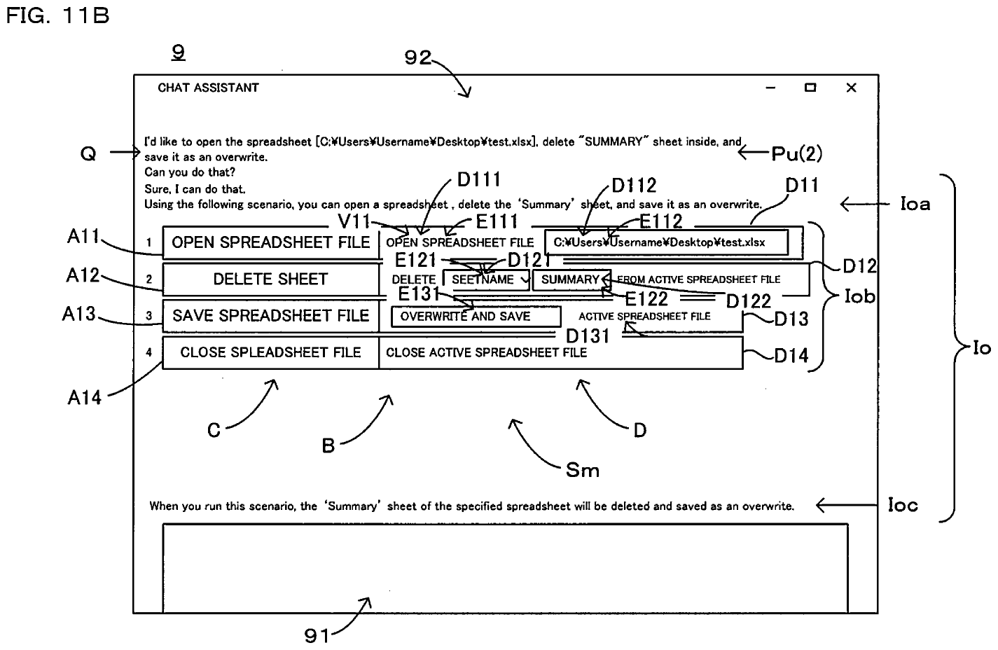

FIGS. 11A and 11B are diagrams schematically illustrating a history display mode on the chat assistant screen in a case where a plurality of user prompts are input. Describing the flow in FIG. 10 specifically, in FIG. 11A, the first user prompt Pu(1), the second user prompt Pu(2), and the second answer W (2) are displayed on the history display unit 92. That is, in order to preferentially display the final user prompt Pu(2) and the answer W (2) to the final user prompt, the answer W (1) to the final user prompt Pu(1) is omitted. On the other hand, in FIG. 11B, the history display unit 92 does not display the first user prompt Pu(1), but displays only the final user prompt Pu(2) and the answer W (2) to the final user prompt Pu(2). Which mode of FIGS. 11A and 11B to display can be determined in accordance with, for example, the input of the user to the chat input unit 91. That is, in a case where only the final prompt is previously input to the chat input unit 91, the final prompt may be displayed in the mode of FIG. 11B, and otherwise, the final prompt may be displayed in the mode of FIG. 11A.

That is, in this example, the chat display information generation unit 56 generates the chat display information Ic not including at least a part of the history display in accordance with the operation of the user accepted by the user instruction acceptance unit 51. As a result, information required by the user can be selectively displayed.

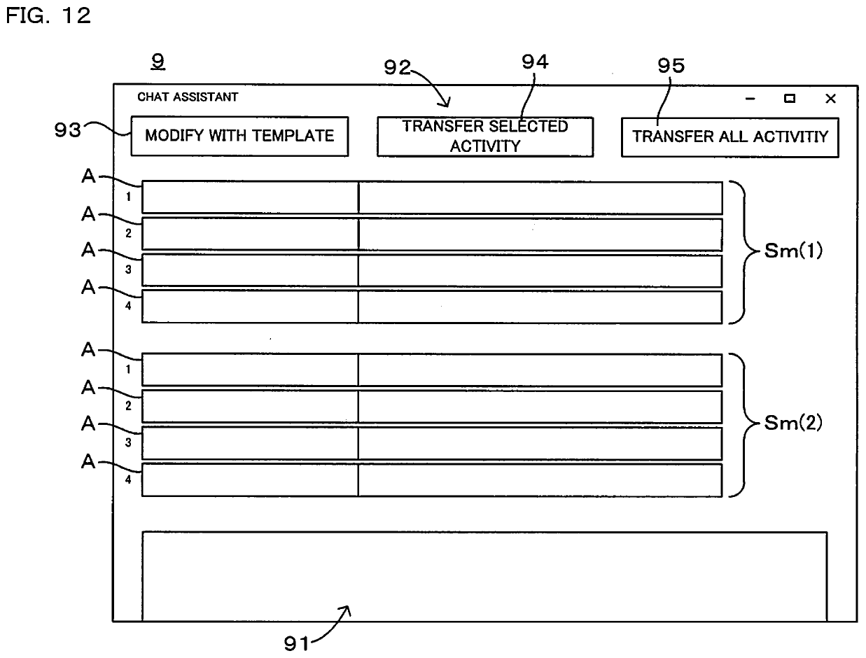

FIG. 12 is a diagram schematically illustrating a modification of the operation using the chat assistant screen. In the history display unit 92 of the chat assistant screen 9 of FIG. 12, a plurality of scenarios Sm(1) and Sm(2) answered from the LLM 12 are illustrated. When the operation of the user on the UI 24 for selecting one scenario Sm among the plurality of scenarios Sm(1) and Sm(2) indicated on the history display unit 92, the user instruction acceptance unit 51 notifies the editor display information generation unit 43 of the one scenario Sm. Then, the editor display information generation unit 43 displays the one scenario Sm on the main scenario screen 83 of the scenario editor screen 8. As a result, the one scenario Sm is edited in accordance with the operation of the user on the UI 24 accepted by the editing operation unit 41.

Further, a correction instruction button 93 is provided on the chat assistant screen 9 of FIG. 12. The correction instruction button 93 is provided to request the LLM 12 to execute predetermined correction on the activity A. That is, the memory 221 stores a correction template indicating predetermined correction such as duplication or deletion of the activity A or change of the variable name. Then, when the user instruction acceptance unit 51 accepts the operation of the user on the UI 24 for selecting the correction instruction button 93 in a state of accepting the operation of the user on the UI 24 for selecting one activity A among the activities A indicated on the history display unit 92, the acquisition unit 54 acquires the correction template from the memory 221. Then, the input information generation unit 52 executes the correction indicated by the correction template acquired from the acquisition unit 54 for the one activity A, generates the input information Ii requesting to answer the source code SC as a result thereof, and inputs the input information Ii to the LLM 12.

In this example, the editing operation unit 41 that retains the source code SC included in the output information Io in an editable mode is provided. In addition, the scenario Sm(1) (first source code) and the scenario Sm(2) (second source code) included in the output information Io acquired by the output information acquisition unit 53 after the scenario Sm(1) are displayed on the history display unit 92. Then, when the user instruction acceptance unit 51 accepts the operation of selecting one of the scenario Sm(1) and the scenario Sm(2), the editing operation unit 41 retains the one scenario Sm in an editable manner. As a result, the user can edit the selected one of the scenarios Sm(1) and Sm(2) acquired in the history of the interaction with the LLM 12.

In addition, the memory 221 (storage unit) retains a correction instruction template for instructing to correct the source code SC. Then, when the user instruction acceptance unit 51 (acceptance unit) accepts an operation input (that is, the operation of selecting the correction instruction button 93) for selecting the correction instruction template in association with the activity block, the acquisition unit 54 (rule information acquisition unit) acquires the correction instruction template from the memory 221, and the input information generation unit 52 (input unit) inputs the source code SC (that is, the source code SC displayed on the history display unit 92) included in the output information Io, the correction instruction template, and the rule information Rg to the LLM 12. As a result, the user can cause the LLM 12 to correct the source code SC by a simple operation input such as selecting the correction instruction template.

Note that the correction template is not limited to one type. That is, a plurality of correction templates indicating different correction contents may be saved in the memory 221, and a plurality of correction instruction buttons 93 corresponding to the plurality of correction templates may be provided on the chat assistant screen 9.

In addition, the scenario Sm to be corrected by the correction instruction button 93 is not limited to the scenario generated by the LLM 12. Accordingly, the correction of the scenario Sm created by the operation on the scenario editor screen 8 may be requested to the LLM 12 by using the correction template corresponding to the correction instruction button 93.

In addition, a transfer selected activity button 94 and a transfer all activity button 95 are provided in the history display unit 92 of FIG. 12. That is, the user instruction acceptance unit 51 notifies the editor display information generation unit 43 of one scenario Sm among the scenarios Sm indicated on the history display unit 92 when the operation of the user on the UI 24 for selecting the transfer selected activity button 94 is accepted in a state where the operation of the user on the UI 24 for selecting the on scenario Sm is accepted. Then, the editor display information generation unit 43 displays the scenario Sm on the main scenario screen 83 of the scenario editor screen 8. In addition, when the operation of the user on the UI 24 for selecting the transfer all activity button 95 is accepted, the user instruction acceptance unit 51 notifies the editor display information generation unit 43 of all the scenarios Sm displayed on the history display unit 92. Then, the editor display information generation unit 43 displays all the scenarios Sm on the main scenario screen 83 of the scenario editor screen 8.

In addition, as illustrated in the following modification, the chat function may be used in a case where an error occurs in the scenario Sm. In this modification, when the occurrence of an error is confirmed when the scenario Sm is executed by execution, partial execution, execution line by line, or the like, the editing operation unit 41 (FIG. 2) saves error information indicating the error in the scenario saving region 61. Here, the error information includes the source code SC of the executed scenario Sm and a content of the generated error. Further, the editing operation unit 41 displays an error screen on the display 244. In particular, the editing operation unit 41 displays a button of “consult with AI navigation” on this error screen.

By contrast, when it is confirmed that the UI 24 accepts the operation of selecting the button, the user instruction acceptance unit 51 notifies the chat display information generation unit 56 of the acceptance, and the chat display information generation unit 56 displays the chat assistant screen 9 on the display 244. In particular, the chat display information generation unit 56 displays the user prompt Pu for an answer to a cause or a solution of the error in advance on the chat input unit 91 of the chat assistant screen 9. For example, when the user presses the Enter key on the keyboard 241, the user instruction acceptance unit 51 delivers the user prompt Pu to the input information generation unit 52. At this time, the acquisition unit 54 acquires the error information from the scenario saving region 61 and delivers the error information to the input information generation unit 52, and the input information generation unit 52 generates the input information Ii including the user prompt Pu and the error information, and inputs the input information Ii to the LLM 12 via the communication unit 25.

The output information acquisition unit 53 acquires, as a response to the input information Ii, the output information Io output from the LLM 12 via the communication unit 25. The output information acquisition unit 53 delivers the output information Io acquired from the LLM 12 to the violation check unit 55. The violation check unit 55 checks whether or not the output information Io received from the output information acquisition unit 53 violates the rule information Rg. Then, the output information Io and a result of the check of the output information Io by the violation check unit 55 are delivered from the violation check unit 55 to the chat display information generation unit 56. The chat display information generation unit 56 converts the output information Io received from the violation check unit 55 into chat display information Ic to be displayed on the display 244, and displays the chat display information Ic on the display 244.

The present invention is applicable to all types of RPA technology for reducing the work load on the user by automating the work executed by the user using the computer.

What is claimed is:

1. A scenario management apparatus that manages a scenario for automating an operation on another application program, the scenario management apparatus comprising:
an acceptance unit that accepts a user instruction in a natural language format by a user;
a rule information acquisition unit that acquires rule information for describing the scenario in a general-purpose programming language from a storage unit;
an input unit that inputs the user instruction accepted by the acceptance unit and the rule information acquired by the rule information acquisition unit to a machine learning model that has learned natural language processing;
an output information acquisition unit that acquires output information including a source code that describes the scenario, the source code being generated by the machine learning model in the general-purpose programming language according to the user instruction and the rule information; and
a display generation unit that converts the source code included in the output information into display information to be displayed on a GUI.

2. A scenario management apparatus that manages a scenario for automating an operation on another application program, the scenario management apparatus comprising:
an acceptance unit that accepts a user instruction in a natural language format by a user;
a rule information acquisition unit that acquires rule information for describing the scenario in a general-purpose programming language from a storage unit;
an input unit that inputs the user instruction accepted by the acceptance unit and the rule information acquired by the rule information acquisition unit to a machine learning model that has learned natural language processing;
an output information acquisition unit that acquires output information including a source code that describes the scenario, the source code being generated by the machine learning model in the general-purpose programming language according to the user instruction and the rule information; and
an editing operation unit that retains the source code included in the output information in a mode editable by the user in the storage unit.

3. The scenario management apparatus according to claim 1, wherein the rule information includes language designation information designating the general-purpose programming language describing the scenario included in the output information.

4. The scenario management apparatus according to claim 3, wherein the rule information includes available function information for designating a function available to the description of the scenario among functions in a programming interface in the general-purpose programming language designated by the language designation information.

5. The scenario management apparatus according to claim 4, wherein the rule information includes a sample code indicating a method for reading the available function indicated by the available function information.

6. The scenario management apparatus according to claim 1, wherein the rule information includes information designating a method for describing the scenario in the general-purpose programming language.

7. The scenario management apparatus according to claim 1, wherein the output information acquisition unit acquires the output information including an explanatory sentence explaining the scenario in a natural language, and
the display generation unit distinguishes the source code and the explanatory sentence of the scenario from the output information and generates the display information including explanatory sentence display based on the explanatory sentence.

8. The scenario management apparatus according to claim 1, wherein the display generation unit generates the display information including input sentence display based on the user instruction accepted by the acceptance unit, the input sentence display and the scenario being associated with each other in the display information.

9. The scenario management apparatus according to claim 8, wherein the scenario includes a plurality of activities that execute predetermined processing defined in the general-purpose programming language,
the acceptance unit retains a first user instruction as the user instruction in the storage unit,
the output information acquisition unit retains first output information as the output information in the storage unit, and
when the acceptance unit accepts a second user instruction as the user instruction after the output information acquisition unit acquires the first output information,
the display generation unit generates the display information in which history display based on the first user instruction and the first output information retained in the storage unit, the input sentence display, and an activity block indicating the activity are associated with each other.

10. The scenario management apparatus according to claim 9, wherein the display generation unit generates the display information not including at least a part of the history display in accordance with an operation of the user accepted by the acceptance unit.

11. The scenario management apparatus according to claim 9, further comprising
an editing operation unit that retains the source code included in the output information in an editable mode,
wherein the history display includes a first source code that is the source code included in the first output information and a second source code that is the source code included in the output information acquired by the output information acquisition unit after the first output information, and
when the acceptance unit accepts an operation of selecting one of the first source code and the second source code, the editing operation unit retains the scenario of the selected one source code in an editable manner.

12. The scenario management apparatus according to claim 9, wherein the storage unit retains a correction instruction template that instructs to correct the source code,
when the acceptance unit accepts an operation input for selecting the correction instruction template in association with the activity block,
the rule information acquisition unit acquires the correction instruction template from the storage unit, and
the input unit inputs the source code included in the output information, the correction instruction template, and the rule information to the machine learning model.

13. The scenario management apparatus according to claim 1, wherein the display generation unit displays, on the GUI, a first window that accepts an input of the user instruction by the user, and a second window different from the first window, the second window displaying the display information converted from the source code by the display generation unit.

14. The scenario management apparatus according to claim 2, wherein the editing operation unit retains only a part of the scenario described by the source code in an editable mode.

15. The scenario management apparatus according to claim 1, further comprising
a violation check unit that checks whether or not the source code included in the output information acquired by the output information acquisition unit violates the rule information,
wherein, when the violation check unit determines that the source code violates the rule information, the display generation unit generates information for displaying, on the GUI, that the source code violates the rule information.

16. A computer-readable recording medium storing a scenario management program causing a computer to function as a scenario management apparatus that manages a scenario for automating an operation on another application program, the scenario management program causing the computer to execute steps of:
accepting a user instruction in a natural language format by a user;
acquiring rule information for describing the scenario in a general-purpose programming language from a storage unit;
inputting the user instruction and the rule information to a machine learning model that has learned natural language processing;
acquiring output information including a source code describes the scenario, the source code being generated by the machine learning model in the general-purpose programming language according to the user instruction and the rule information; and
retaining the source code included in the output information in a mode editable by the user in the storage unit.

17. The recording medium according to claim 16, further comprising
converting the source code included in the output information into display information to be displayed on a GUI.
